(19) United States
(12) Patent Application Publication
(10) Pub. No.: US 2025/0303398 A1
(43) Pub. Date: Oct. 2, 2025

(54) CATALYST, SYSTEM AND METHOD FOR MINERALIZATION OF ORGANIC POLLUTANTS

(71) Applicant: Yale University, New Haven, CT (US)

(72) Inventors: Jaehong Kim, New Haven, CT (US); Shuo Zhang, New Haven, CT (US)

(21) Appl. No.: 18/864,353

(22) PCT Filed: May 12, 2023
(86) PCT No.: PCT/US2023/066923

§ 371 Date: Nov. 8, 2024

Related U.S. Application Data
(60) Provisional application No. 63/341,178, filed on May 12, 2022.

(51) Int. Cl. B01J 27/26; B01D 61/14; B01D 69/14; B01J 35/59; B01J 37/02; B01J 37/08; C02F 1/44; C02F 1/72; C02F 101/30; C02F 101/34; C02F 101/36; C02F 101/38; C02F 103/28; C02F 103/32

(52) U.S. Cl. CPC B01J 27/26; B01D 61/145; B01D 61/147; B01D 69/145; B01J 35/59; B01J 37/0203; B01J 37/088; C02F 1/444; C02F 1/722; C02F 1/725; C02F 2101/308; C02F 2101/34; C02F 2101/36; C02F 2101/38; C02F 2103/28; C02F 2103/32

(57) ABSTRACT

Disclosed herein is a catalytic comprising a hexacyano metal compound; wherein the hexacyano metal compound comprises a metal selected from the group consisting of cobalt, iron, copper, manganese, nickel, zinc, and combinations thereof; wherein the hexacyano metal compound comprises coordinatively unsaturated metal (II)—N—C centers for; and wherein the hexacyano metal compound is anchored onto an inorganic substrate. Also disclosed are a system including the catalytic material and a process for treating wastewater using the catalytic material.

### CROSS-REFERENCE TO RELATED APPLICATIONS

This application claims priority to U.S. Provisional Application No. 63/341,178, filed May 12, 2022, which is hereby incorporated herein by reference in its entirety.

### STATEMENT REGARDING FEDERALLY SPONSORED RESEARCH OR DEVELOPMENT

This invention was made with government support under Contract No. EEC-1449500, awarded by the National Science Foundation. The government has certain rights in the invention.

### BACKGROUND OF THE INVENTION

Discharge of anthropogenic organic pollutants from domestic and industrial wastewaters into natural water presents a global concern for ecosystem and human health. Many such pollutants cannot be effectively removed by conventional biological wastewater treatment processes. Advanced physicochemical treatment processes such as adsorption and membrane filtration produce pollutant-laden solids and concentrates without permanently ridding them from the environment. One viable alternative is advanced oxidation processes (AOPs) which utilize highly reactive radical oxidants such as hydroxyl and sulfate radicals (OH and SO₄′—) that are produced on site by activating precursors such as hydrogen peroxide (H₂O₂) and peroxymonosulfate (PMS). While AOPs can oxidatively destroy a wide range of organic pollutants, some oxidation byproducts such as aldehydes (Luster-Teasley, S. L., et al., Environ. Sci. Technol. 36, 869-876 (2002)) and organohalides (Lei, Y., et al., Environ. Sci. Technol. 55, 689-699 (2021); Wert, E. C., et al., Water Res. 41, 1481-1490 (2007)) can pose greater health risk than their parents compounds (von Gunten, U. Environ. Sci. Technol. 52, 5062-5075 (2018); Freeman, L. E. B., et al., Environ. Health Persp. 125, CID: 067010 (2017); Allen, J. M., et al., Environ. Sci. Technol. 56, 392-402 (2022)). Concurrent with advances in materials and processes to enable the broader application of AOP, an increasing number of byproducts are identified with concerning toxicity, persistence, and bioaccumulation (Escher, B. I. & Fenner, K. Environ. Sci. Technol. 45, 3835-3847 (2011)).

Complete oxidation of pollutants (i.e., mineralization of organics to CO₂) is an ideal treatment goal, but challenging for current AOPs. Even energy-intensive AOPs employing UV-irradiation and electric current (Steter, J. R., et al., Appl. Catal. B-Environ. 224, 410-418 (2018); dos Santos, A. et al., Electrochim. Acta. 376, 138034 (2021)) typically achieve less than 50% mineralization, measured in terms of total organic carbon (TOC) removal, even after several hours of operation. One of the reasons for the difficulty in mineralization is the formation of more oxygen-rich organics during the course of oxidation (Dorfman, L. M. & Adams, G. E. National Bureau of Standards Chapter VI, 1-59 (1974); Buxton, G. V., et al., J. Phys. Chem. Ref. Data 17, 513-886 (1988)) and consequently mineralization of the byproducts requires significant enhancement in radical production. However, the availability of OH is impaired by natural organic matter and inorganic constituents in wastewaters that competitively consume OH (Grebel, J. E., et al., Environ. Sci. Technol. 44, 6822-6828 (2010); Lindsey, M. E. & Tarr, M. A. Environ. Sci. Technol. 34, 444-449 (2000)). While various AOPs that employ heterogeneous transition-metal catalysts have been explored to increase radical generation rate (Hodges, B. C., et al., Nat. Nanotechnol. 13, 642-650 (2018)), their extremely short lifetimes (e.g., <10 μs for *OH in water) drastically decrease radical concentrations from the site of generation (i.e., catalyst surface) (Zhang, S., et al., Environ. Sci. Technol. 54, 10868-10875 (2020)).

There is a need in the art for a more effective AOP treatment of water and wastewater that can lead to effective oxidation of organic pollutants. This invention satisfies this unmet need.

### SUMMARY OF THE INVENTION

In one aspect, the present invention relates to a catalytic material comprising a hexacyano metal compound; wherein the hexacyano metal compound comprises a metal selected from the group consisting of cobalt, iron, copper, manganese, nickel, zinc, and combinations thereof; wherein the hexacyano metal compound comprises coordinatively unsaturated metal (II)—N—C centers; and wherein the hexacyano metal compound is anchored onto an inorganic substrate. In one embodiment, the inorganic substrate comprises inorganic granules or porous inorganic scaffolds. In one embodiment, the porous inorganic scaffold is a ceramic microfiltration membrane or a ceramic ultrafiltration membrane. In one embodiment, the catalytic material is disposed within the interstitial spaces of the porous inorganic scaffold. In one embodiment, the porous inorganic scaffold is a water filtration membrane. In one embodiment, the interstitial spaces range in size from 1 to 500 nanometers.

In one embodiment, the hexacyano metal compound includes specific facets. In one embodiment, wherein the specific facets comprise dominant (400) and (220) facets. In one embodiment, the hexacyano metal compound comprises cobalt hexacyanocobaltate with dominant (400) and (220) facets.

In one embodiment, the catalytic material exhibits effective peroxide activation; wherein effective peroxide activation includes breaking peroxide bonds in a peroxide precursor selected from the group consisting of peroxymonosulfate, peroxydisulfate, peracetic acid, percarbonic acid, percarbonate, hydrogen peroxide and combinations thereof. In one embodiment, the effective peroxide activation produces reactive radicals selected from the group consisting of hydroxyl radicals, sulfate radicals, acetate radicals, carbonate radicals and combinations thereof. In one embodiment, a residual peroxide concentration after effective peroxide activation is less than 10 ppm. In one embodiment, the effective peroxide activation degrades organic pollutants in aqueous sources.

In one aspect, the present invention relates to a method of making a catalytic material, the method comprising the steps of. providing a solution comprising a metal salt and an organic substrate precursor; and heating the solution under pressure to form a catalytic material; wherein the metal salt comprises a metal selected from the group consisting of cobalt, iron, chromium, copper, manganese, nickel, vanadium, zinc and combinations thereof. In one embodiment, the method further comprises the steps of contacting the solution comprising a metal salt and an organic substrate precursor with an inorganic substrate; and heating the combination of the inorganic substrate and the solution at an effective temperature and for a sufficient time to form and anchor the catalytic material onto the inorganic substrate.

In one embodiment, the metal salt is a metal nitrate. In one embodiment, the organic substrate precursor is selected from the group consisting of a soluble carbohydrate, an alcohol, a carboxylic acid, and combinations thereof. In one embodiment, the soluble carbohydrate is selected from the group consisting of glucose, sucrose, fructose, galactose, lactose, maltose and combinations thereof. In one embodiment, the metal salt is cobalt nitrate and the organic precursor is glucose. In one embodiment, the inorganic substrate includes interstitial spaces ranging in size from 1 to 500 nanometers. In one embodiment, the inorganic substrate comprises a ceramic material. In one embodiment, the ceramic material comprises inorganic granules or a porous inorganic scaffold. In one embodiment, the porous inorganic scaffold is a ceramic microfiltration membrane or a ceramic ultrafiltration membrane. In one embodiment, the catalytic material is disposed within the interstitial spaces of the inorganic substrate. In one embodiment, the porous inorganic scaffold is a water filtration membrane.

In one aspect, the present invention relates to an oxidation process system comprising a containerized vessel, said containerized vessel comprising a catalytic material anchored to a porous inorganic scaffold; wherein the catalytic material comprises a hexacyano metal compound; wherein the hexacyano metal compound comprises a metal selected from the group consisting of cobalt, iron, copper, manganese, nickel, and zinc; and wherein the hexacyano metal compound comprises coordinatively unsaturated metal (II)—N—C centers. In one embodiment, the system further comprises an aqueous source comprising organic pollutants. In one embodiment, the aqueous source is selected from the group consisting of municipal wastewater, industrial wastewater, ground water, and surface water. In one embodiment, the system degrades the organic pollutants. In one embodiment, the containerized vessel is selected from the group consisting of a packed bed reactor, a pressurized membrane reactor, a batch reactor, a semi-batch reactor, a pulsed bed reactor, a fixed-bed reactor, and a plug flow reactor. In one embodiment, the containerized vessel includes a means for agitation selected from the group consisting of an agitator, a baffle, an impellor and combinations thereof. In one embodiment, the system is a portable self-contained unit or incorporated into a non-portable structure.

In one embodiment, the hexacyano metal compound includes specific facets. In one embodiment, the specific facets comprise dominant (400) and (220) facets. In one embodiment, the hexacyano metal compound comprises cobalt hexacyanocobaltate with dominant (400) and (220) facets. In one embodiment, the inorganic substrate comprises a ceramic material. In one embodiment, the inorganic substrate comprises inorganic granules or a porous inorganic scaffold. In one embodiment, the porous inorganic scaffold is a ceramic microfiltration membrane or a ceramic ultrafiltration membrane. In one embodiment, the catalytic material is disposed within the interstitial spaces of the porous inorganic scaffold. In one embodiment, the porous inorganic scaffold is a water filtration membrane. In one embodiment, the interstitial spaces range in size from 1 to 500 nanometers.

In one embodiment, the peroxide precursor is selected from the group consisting of hydrogen peroxide, peroxymonosulfate, peroxydisulfate, peracetic acid, and percarbonate. In one embodiment, the system exhibits effective peroxide activation; wherein effective peroxide activation includes breaking peroxide bonds in the peroxide precursor selected from the group consisting of peroxymonosulfate, peroxydisulfate, peracetic acid, percarbonic acid, percarbonate, hydrogen peroxide and combinations thereof. In one embodiment, the effective activation produces reactive radicals selected from the group consisting of hydroxyl radicals, sulfate radicals, acetate radicals, carbonate radicals and combinations thereof. In one embodiment, a residual peroxide concentration is less than 10 ppm.

In one aspect, the present invention relates to an oxidation process for treating an aqueous source comprising the step of: contacting an aqueous source with a peroxide precursor in the presence of a catalytic material; wherein the catalytic material comprises hexacyano metal compound anchored onto an inorganic substrate; wherein the hexacyano metal compound comprises a metal selected from the group consisting of cobalt, iron, copper, manganese, nickel, zinc and combinations thereof, and wherein the hexacyano metal compound comprises coordinatively unsaturated metal (II)—N—C centers. In one embodiment, the step of contacting the peroxide precursor with the aqueous solution in the presence of the catalytic material further comprises the step of breaking the peroxide bonds in the peroxide precursor; wherein the peroxide precursor is selected from the group consisting of peroxymonosulfate, peroxydisulfate, peracetic acid, percarbonic acid, percarbonate, hydrogen peroxide and combinations thereof. In one embodiment, the step of breaking the peroxide bonds in the peroxide precursor produces reactive radicals selected from the group consisting of hydroxyl radicals, sulfate radicals, acetate radicals, carbonate radicals and combinations thereof. In one embodiment, a residual peroxide concentration is less than 10 ppm. In one embodiment, the aqueous source comprises organic pollutants. In one embodiment, the aqueous source is selected from the group consisting of municipal wastewater, industrial wastewater, ground water, and surface water. In one embodiment, the effective peroxide activation degrades the organic pollutants in the aqueous sources.

In one embodiment, the hexacyano metal compound includes specific facets. In one embodiment, the specific facets comprise dominant (400) and (220) facets. In one embodiment, the hexacyano metal compound comprises cobalt hexacyanocobaltate with dominant (400) and (220) facets.

In one embodiment, the inorganic substrate comprises a ceramic material. In one embodiment, the inorganic substrate comprises inorganic granules or a porous inorganic scaffold. In one embodiment, the porous inorganic scaffold is a ceramic microfiltration membrane or a ceramic ultrafiltration membrane. In one embodiment, the catalytic material is disposed within interstitial spaces of the porous inorganic scaffold. In one embodiment, the porous inorganic scaffold is a water filtration membrane. In one embodiment, the interstitial spaces range in size from 1 to 500 nanometers.

The invention is not intended to be limited by the specific embodiments disclosed herein, and any combination of these embodiments (or portions thereof) may be made to define further embodiments.

### BRIEF DESCRIPTION OF THE DRAWINGS

The following detailed description of preferred embodiments of the invention will be better understood when read in conjunction with the appended drawings. For the purpose of illustrating the invention, there are shown in the drawings embodiments which are preferred. It should be understood, however, that the invention is not limited to the precise arrangements and instrumentalities of the embodiments shown in the drawings.

FIG. 1 depicts a schematic diagram of the hydrothermal reaction processes for the synthesis of the spherical Co—HCC catalyst.

FIG. 2 is a scanning electron microscope (SEM) image of the Co—HCC particles.

FIG. 3 is a plot of the hydrodynamic particle size distribution of Co—HCC (the tested concentration was reduced to 0.02 g L⁻¹ to avoid aggregation).

FIG. 4 is a high-resolution TEM image of the layered catalyst structure. Inset figure is the original TEM image (scale bar, 500 nm).

FIG. 5 depicts a SEM image (top left); XRD diffraction pattern (top right); and C1s XPS spectra (bottom) for the spherical nanoparticles synthesized using glucose as the carbon precursor under the same hydrothermal condition (260° C., 15 h). The deconvoluted peaks are attributed to the sp² (284.5 eV) and sp³ (285.0 eV)C—C, ethers or hydroxyl groups (C—O—C/C—OH, 285.7 eV), carbonyl groups (C═O, 287.3 eV), and carboxylic groups (COOH, 288.6 eV), respectively.

FIG. 6 depicts XPS spectra of Co—HCC for C1s (left) and N1s (right). The C—N bond can be reflected by the fitted energy peaks at about 285.6 eV for C1s spectrum and 399.6 eV for N1s.

FIG. 7 is a STEM of the Co—HCC particle (scale bar, 500 nm).

FIG. 8 depicts XRD patterns of the synthesized Co—HCC. Inset figure is the photograph of the black powder. The reference cobalt hexacyanocobaltate crystal is the same as that synthesized by the standard precipitation method (i.e., Co—HCCₚᵣₑ).

FIG. 9 depicts the EDS elemental content analysis for Co—HCC: left=SEM image; right=designated atom ratios; bottom=EDS spectrum.

FIG. 10 is an XPS spectra of the Co2p for Co—HCC. The coexisting Co^{II} (783.0 eV) and Co.. (781.5 eV) can be evidenced by the fitted peaks of Co2p.

FIG. 11 is a XANES spectra of the Co—HCC, Co—CN (K₃Co(CN)₆ reference), Co—Co (Co foil reference), and Co—O (CoO reference). Comparison of white line intensity of Co—HCC with references indicates that the average valence state for the Co atom is higher than +2, in agreement with the XPS result.

FIG. 12 is an FT-EXAFS spectra of the Co—HCC with Co—N/C, K₃Co(CN)₆ reference with Co—C—N, Co foil reference with Co—Co, and CoO reference with Co—O, respectively.

FIG. 13 is a plot of the R-space (left) k³-weighted k-space fittings (right) of Co—HCC using Co—C—N(K₃Co(CN)₆). R-space fit ranged from 1-3.5 Å and k-space fit ranged from 3-12 Å⁻¹.

FIG. 14 depicts a schematic diagram for the crystal structure of Co—HCC with a high-density of unsaturated “Co^{II}—N—C” coordination units at the outer surface.

FIG. 15 is a plot showing the evolution of normalized BPA concentration under different reaction conditions. Conditions: PMS concentration, 0.4 mM, BPA concentration, 20 μM, Catalyst load, 2.5×10⁻⁴ g L⁻¹, Solution pH, 7.0, Methanol, 10 mM, TBA, 2 mM.

FIG. 16 depicts the EPR signals for PMS alone and PMS/catalyst systems. Conditions: PMS concentration, 0.4 mM, Catalyst load, 0.01 g L⁻¹ for Co—HCC, and 0.1 g L⁻¹ for C0304 and CoFe₂O₄, respectively, DMPO concentration, 0.1 mM.

FIG. 17 depicts a schematic diagram of 5,5-dimethyl-1-pyrroline N-oxide (DMPO) in reaction with SO₄·⁻ and OH. No signal was detected for the intermediate DMPO-OH, even though an overdosed amount of methanol as radical quencher was immediately added after the addition of DMPO. Thus, he DMPO-OH must disappear very fast in reaction with SO₄·⁻ and transform into 5,5-dimethyl-2pyrrolidone-N-oxyl (DMPOX).

FIG. 18 is a series of plots showing the Evolution of normalized BPA concentration versus time using CO₃O₄ (left) and CoFe₂O₄ (right) catalysts. The correlations of the kinetic data for the determination of pseudo-first-order constant were higher than 0.98. The bottom figures are the XRD patterns of the as-synthesized catalyst and the standard PDF card for CO₃O₄ and CoFe₂O₄, respectively. Conditions: PMS concentration, 0.4 mM; BPA concentration, 20 μM; Solution pH, 7.0.

FIG. 19 depicts the XRD pattern of cobalt(II) hexacyanocobaltate synthesized by the standard precipitation method (i.e., Co—HCCₚᵣₑ). Inset picture shows the pink color of this precipitate.

FIG. 20 is a plot depicting the evolution of normalized BPA concentration in PMS solutions with heterogeneous catalysts (Co—HCC, Co—HCCₚᵣₑ, CO₃O₄, and CoFe₂O₄), homogeneous ions (Co²⁺ cation or [Co(bCN)₆]³⁻ anion), and without catalyst. Conditions: PMS concentration, 0.4 mM, BPA concentration, 20 μM, Catalyst load, 2.5×10⁻³ g L⁻¹ for Co—HCCₚᵣₑ, and 0.25 g L⁻¹ for CO₃O₄ and CoFe₂O₄, Co²⁺, 3 μM, [Co(CN)₆]³⁻, 10 μM, Solution pH, 7.0.

FIG. 21 is a chart showing the TOFs for Co—HCC and reported cobalt-based catalyst structures. Detailed information for the references consecutively numbered from 1 to 31 are listed in Table 1.

FIG. 22 is a series of Free energy diagrams for PMS activation on Co—HCC. Top left=Path I on (100) facet; top right=Path I on (110) facet; bottom left=Path II on (100) facet; bottom right=Path II on (110) facet.

FIG. 23 depicts the turnover of Co^{II}-Co^{III} in Co—HCC for the activation of PMS.

FIG. 24 depicts DFT structures for PMS activation on Co—HCC (100) and Co—HCC (110) facets.

FIG. 25 depicts a free energy diagram for PMS activation on Co₃[Co(CN)₆]₂ (100) and (110) with the production of SO₄·⁻ and adsorbed OH* (identified as Path I).

FIG. 26 depicts DFT-optimized structures for PMS activation on CO₃O₄, CoFe₂O₄, and CoN₄, respectively.

FIG. 27 depicts a free energy diagram for the PMS activation on CO₃O₄ (311), CoFe₂O₄ (311), and CoN₄ with the production of SO₄·⁻ and adsorbed OH*.

FIG. 28 is a plot of the PDOS of Co 3d and 0 2p orbitals for HSO₅* on Co—HCC (110), CO₃O₄ (311), CoFe₂O₄ (311), and CoN₄.

FIG. 29 depicts the charge density difference for HSO₅* adsorption on Co—HCC (100) and Co—HCC (110) facets.

FIG. 30 depicts the in situ synthesis of Co—HCC network structure within ceramic membrane channels. Relevant figures are the photographs and cross-sectional SEM images of bare ceramic membrane (top) and Co—HCC-functionalized ceramic membrane (bottom).

FIG. 31 depicts the cross-sectional EDS mapping of ceramic membrane with incorporated Co—HCC catalyst.

FIG. 32 depicts the EDS elemental content analysis for the ceramic UF membrane containing the Co—HCC catalyst: top left=SEM image; top right=designated atom ratios; bottom=EDS spectrum.

FIG. 33 is a plot depicting the Fast degradation of BPA through membrane-confined AOP with the feed organic concentrations of 10 and 100 μM, respectively. Conditions for inlet solution: PMS concentration, 0.4 mM, solution pH, 7.0, the permeate samples were collected after 1 h runtime under certain water fluxes.

FIG. 34 is a plot of the removal of BPA versus water flux through bare ceramic membrane with PMS and catalyst membrane without PMS. Conditions for inlet solution: BPA concentration, 10 μM; PMS concentration, 0.4 mM; solution pH, 7.0; the permeate samples were collected after 2 h runtime under fixed water fluxes.

FIG. 35 is a graph of the mineralization efficiency by membrane-confined AOP compared to the traditional UV/H₂O₂ and UV/TiO₂ processes. Conditions for membrane treatment: water flux, 20 LMH, BPA concentration, 0.6 mM (TOC≈108 mgC L⁻¹), PMS concentration, 20 mM, solution pH, 7.0, NOM concentration, 100 mg L⁻¹. Conditions for batch UV treatment: UV reactor (Rayonet, Models RPR-100) with 16 UVA lamps (λ=350 nm, RPR-3500 Å, SNE ultraviolet Co. USA), BPA concentration, 0.6 mM (TOC≈108 mgC L⁻¹), solution pH, 7.0, H₂O₂ concentration, 30 mM, TiO₂ powder, 0.5 g L⁻¹.

FIG. 36 is a plot of the mineralization efficiency versus water flux. Conditions for inlet solution: BPA concentration, 0.6 mM (TOC≈108 mgC L⁻¹), PMS concentration, 20 mM, solution pH, 7.0.

FIG. 37 is a plot depicting the result of a Kinetic study based on the normalized permeate TOC (TOCₒᵤₜ/TOCᵢₙ) versus retention time for the catalytic membrane based AOP treatment. Inset figure is the linear regression analysis on the logarithm of permeate TOC (TOCₒᵤₜ) at different retention times versus the inlet value (TOCᵢₙ). Conditions for inlet solution: BPA concentration, 0.6 mM (TOC≈108 mg L⁻¹); PMS concentration, 20 mM; solution pH, 7.0.

FIG. 38 is a graph depicting membrane-confined mineralization of some typical industrial wastewaters with representative organic contaminants (Tables 2 to 4 list detailed information of the quality of simulated wastewaters). The full names of RhB, APAP, TPA, 4-CP, and OA are Rhodamine B, acetaminophen, terephthalic acid, 4-chlorophenol, and oxalic acid, respectively. Conditions: the initial TOC values were 90-110 mg C L⁻¹ for all the industries, PMS concentration, 20 mM, water flux, 10 LMH.

FIG. 39 is a plot of the evolution of the TOC removal versus time for UV/H₂O₂ and UV/TiO₂ treatment systems. Conditions: UV reactor (Rayonet, Models RPR-100) with 16 UVA lamps (λ=350 nm; RPR-3500 Å, SNE ultraviolet Co. USA); BPA concentration, 0.6 mM (TOC≈108 mg L⁻¹); solution pH, 7.0; H₂O₂ concentration, 30 mM; TiO₂ powder, 0.5 g L⁻¹.

FIG. 40 is a graph depicting the mineralization efficiency by two membranes working in series operated under 20 LMH. Conditions for membrane treatment: BPA concentration, 0.6 mM (TOC≈108 mg L⁻¹); PMS concentration, 20 mM; solution pH, 7.0; NOM concentration, 100 mg L⁻¹.

FIG. 41 is a plot depicting the removal of BPA through our membrane-confined AOP in the presence of concentrated Cl⁻ and HCO₃⁻. Conditions for inlet solution: BPA concentration, 0.6 mM; Cl⁻ concentration, 500 mg L⁻¹; HCO₃⁻ concentration, 500 mg L⁻¹; PMS concentration, 20 mM; the permeate samples were collected after 1 h runtime under fixed water fluxes.

FIG. 42 is a plot of the consumption of PMS versus retention time under different water flux operation conditions. The initial concentration of PMS was set at 20 mM. The retention times of 9.75, 19.5, 39, 195, 390, and 780 s, were operated under the water fluxes of 400, 200, 100, 20, 10, and 5 LMH, respectively.

FIG. 43 is a plot of the removal of TOC during a long-term operation of our membrane AOP. Conditions: tested water was simulated municipal wastewater spiked with 4-chlorophenol and 20 mg L⁻¹NOM; initial TOC value, 100 mg L⁻¹; PMS concentration, 20 mM; water flux, 10 LMH. The stock solution was renewed every 24 hours.

FIG. 44 is a plot depicting the TOC removal rate versus EEO for our membrane reactor compared to reported works with extra UV and/or electrical energies (detailed information for the referenced work is shown in Table 5).

FIG. 45 is a plot depicting the estimated total cost and efficiency for a near-complete mineralization (>90% TOC removal) done by our membrane system and the referenced works in Table 5.

FIG. 46 depicts the atomic structures (left) and Gibbs free energies (right) for the DFT calculation of SO₄·⁻ to OH transformation that occurred in the aqueous phase and on the catalyst surface (110) facet. TS stands for the transition state.

FIG. 47 is a time-resolved dynamic light scattering (DLS) measurements at different particle concentrations. The DLS signal was acquired every 10 s for each tested concentration.

### DETAILED DESCRIPTION

The invention can be understood more readily by referencing to the following detailed description, examples, drawings, and claims, and their previous and following description. However, it is to be understood that this invention is not limited to the specific compositions, articles, devices, systems, and/or methods disclosed unless otherwise specified, and as such, of course, can vary. While aspects of the invention can be described and claimed in a particular statutory class, such as the composition of matter statutory class, this is for convenience only and one of skill in the art will understand that each aspect of the invention can be described and claimed in any statutory class.

It is to be understood that the figures and descriptions of the invention have been simplified to illustrate elements that are relevant for a clear understanding of the invention, while eliminating, for the purpose of clarity, many other elements found in AOP, AOP-enabled filtration, and related system components. Those of ordinary skill in the art may recognize that other elements and/or steps are desirable and/or required in implementing the invention. However, because such elements and steps are well known in the art, and because they do not facilitate a better understanding of the invention, a discussion of such elements and steps is not provided herein. The disclosure herein is directed to all such variations and modifications to such elements and methods known to those skilled in the art.

While the invention is capable of being embodied in various forms, the description below of several embodiments is made with the understanding that the disclosure is to be considered as an exemplification of the invention and is not intended to limit the invention to the specific embodiments illustrated. Headings are provided for convenience only and are not to be construed to limit the invention in any manner. Embodiments illustrated under any heading or in any portion of the disclosure may be combined with embodiments illustrated under the same or any other heading or other portion of the disclosure.

Any combination of the elements described herein in all possible variations thereof is encompassed by the invention unless otherwise indicated herein or otherwise clearly contradicted by context.

Unless otherwise expressly stated, it is in no way intended that any method or aspect set forth herein be construed as requiring that its steps be performed in a specific order. Accordingly, where a method claim does not specifically state in the claims or description that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of embodiments described in the specification. It is to be understood that both the foregoing general description and the following detailed description are exemplary and explanatory only and are not restrictive.

All publications mentioned herein are incorporated herein by reference to disclose and describe the methods and/or materials in connection with which the publications are cited.

As used herein, each of the following terms has the meaning associated with it in this section. Unless defined otherwise, all technical and scientific terms used herein generally have the same meaning as commonly understood by one of ordinary skill in the art to which this invention belongs.

The articles “a” and “an” are used herein to refer to one or to more than one (i.e., to at least one) of the grammatical object of the article. By way of example, “an element” means one element or more than one element.

As used herein, the terms “optional” or “optionally” mean that the subsequently described event, condition, component, or circumstance may or may not occur, and that the description includes instances where said event, condition, component, or circumstance occurs and instances where it does not.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range. Further, for lists of ranges, including lists of lower preferable values and upper preferable values, unless otherwise stated, the range is intended to include the endpoints thereof, and any combination of values therein, including any minimum and any maximum values recited.

### Catalytic Materials

In one aspect, the present invention relates in part to a catalytic material comprising a hexacyanometal compound; wherein the hexacyano metal compound comprises a metal selected from the group consisting of cobalt, iron, copper, manganese, nickel, zinc, and combinations thereof, wherein the hexacyano metal compound comprises coordinatively unsaturated metal (II)—N—C centers; and wherein the hexacyano metal compound is anchored onto an inorganic substrate. In one embodiment, a metal compound is anchored to an inorganic substrate when the compound is covalently bound to the inorganic substrate. I

In some embodiments, the hexacyanometal compound effectively activates peroxides. As used herein, “effective peroxide activation” means breaking peroxide bonds in a peroxide molecules or peroxide precursor molecules such as peroxy-monosulfate, peroxydisulfate, peracetic acid, percarbonic acid, and hydrogen peroxide to produce reactive radicals such as hydroxyl radical, sulfate radical, acetate radical, carbonate radical and combinations therefore to induce pollutant degradation in water. As used herein, “Effective peroxide activation” also means that no residual peroxide exists at the end of the reaction, or that the residual peroxide concentration at the end of the reaction is less than the detection limit, or that the residual peroxide concentration at the end of the reaction is less than 10 ppm, or less than 5 ppm, or less than 3 ppm, or less than 1 ppm. In one embodiment, the effective peroxide activation produces reactive radicals selected from the group consisting of hydroxyl radicals, sulfate radicals, acetate radicals, carbonate radicals and combinations thereof. In one embodiment, a residual peroxide concentration after effective peroxide activation is less than 10 ppm. In one embodiment, the effective peroxide activation degrades organic pollutants in aqueous sources.

In some embodiments, the hexacyano metal compound includes specific facets. In one embodiment, the specific facets comprise dominant (400) and (220) facets. In one embodiment, the hexacyano metal compound comprises cobalt hexacyanocobaltate with dominant (400) and (220) facets. In one embodiment, the facet composition of the hexacyanometal compound facilitates the activation of a peroxide precursor.

In one embodiment, the hexacyano metal compound comprises a metal selected from the group consisting of cobalt, iron, copper, manganese, nickel, vanadium, chromium, and zinc. Combinations of these metals are also contemplated. The hexacyano metal compound comprises a transition metal having a mixture of oxidation states. For example, the hexacyano metal compound may comprise one of a mixture of Fe^{II}/Fe^{III}, Co^{II}/Co^{III}, V^{III}/V^{IV}/V^{V}, Cu^{I}/Cu^{II}, Cr^{II}/Cr^{II}/Cr^{IV}, or Ni⁰/Ni^{I}/Ni^{II} oxidation states. In one embodiment, one or more transition metal having a specific oxidation state may be atomically-isolated. In one embodiment, one or more transiotn metals having a specific oxidation state, such as any of the oxidation states described above, may be coordinatively or oxidatively unsaturated, rendering them more reactive in catalytic processes.

In one embodiment, the hexacyano metal compound comprises cobalt (Co). In one embodiment, the hexacyanometal compound comprises a mixture of Co^{II} and Co^{II}. metal centers. In one embodiment, the Co^{II} metal centers are unsaturated and/or atomically-isolated. In one embodiment, the hexacyano metal complex comprises a material having the formula Co^{II}—N—C—Co^{III}. In one embodiment, the hexacyanometal compound comprises atomically-isolated Co^{II}—NC metal centers.

In one embodiment, the catalyst is disposed within interstitial space of a porous medium or a porous inorganic scaffold. Exemplary porous media or scaffolds include packed media such as polymeric scaffolds, glass/ceramic media (e.g., particles), sand, and filtration membranes such as microfiltration and ultrafiltration membranes and fiber filters In one embodiment, the porous medium has interstitial spaces which may be micrometer- to nanometer-sized. “Nanometer-sized” in this context, described spaces which have no single linear dimension greater than 100 nanometers (nm), or no greater than 500 nm, or no greater than 1000 nm. In one embodiment, the interstitial spaces have a minimum linear dimension between 1 nm and 1000 μm. In one embodiment, the interstitial spaces range in size from 1 nm to 500 nm. In one embodiment, the interstitial spaces have a minimum linear dimension between 25 and 30 nm. In one embodiment, the inorganic substrate comprises inorganic granules or porous inorganic scaffolds. In some embodiments the size of the interstitial spaces may be used to exclude colloids, particles, microorganisms, and organic matter that are present in wastewater, thereby reducing the quantity of material that contacts the catalytic material. In one embodiment, the porous inorganic medium or scaffold comprises a water filtration membrane.

In one embodiment, the porous inorganic scaffold comprises a ceramic microfiltration membrane or a ceramic ultrafiltration membrane. In one embodiment, the ceramic micro- or ultrafiltration membrane comprises ZrO₂ and TiO₂. In one embodiment, the ceramic micro- or ultrafiltration membrane has a pore diameter between 1 nm and 1000 nm. In one embodiment, ceramic micro- or ultrafiltration membrane has a pore diameter between 5 and 500 nm. In one embodiment, the ceramic micro- or ultrafiltration membrane has a pore diameter between 10 and 250 nm. In one embodiment, the ceramic micro- or ultrafiltration membrane has a pore diameter between 15 and 100 nm. In one embodiment, the ceramic micro- or ultrafiltration membrane has a pore diameter of at least 10 nm. In one embodiment, the ceramic micro- or ultrafiltration membrane has a pore diameter of at least 20 nm. In one embodiment, the ceramic micro- or ultrafiltration membrane has a pore diameter of no more than 1000 nm. In one embodiment, the ceramic micro- or ultrafiltration membrane has a pore diameter of no more than 900, 800, 700, 600, 500, 400, 300, 200, or 100 nm. In one embodiment, the ceramic micro- or ultrafiltration membrane has a pore diameter of no more than 100, 90, 80, 70, 60, 50, 40, 30, or 20 nm.

In one embodiment, the catalytic material comprises a core-shell particle material. In one embodiment, the core-shell particle material comprises a shell material displosed over the core material. In one embodiment, the core material is covalently bound to the shell material. In one embodiment, the core-shell particle material forms a spherical or semi-spherical particle. In one embodiment, the hexacyano metal compound forms the shell or the core of the core-shell particle material. In one embodiment, the hexacyano metal compound forms the shell of the core-shell particle. In one embodiment, the core-shell particle comprises a carbon core and a hexacyano metal compound shell. In one embodiment, the core is covalently bound to the shell. In one embodiment, the

In one embodiment the core-shell particle comprises a spherical or semi-spherical core with a shell material disposed over the entirety near-entirety of the core. For example, in some embodiments, the core material may be covalently bound to the porous inorganic medium or porous inorganic scaffold—in such an embodiment, the shell may be incontiguous due to the presence of the inorganic porous media. In some embodiments, the hexacyano metal compound has a layered morphology.

### Methods of Making

In another aspect, the present invention relates to a method of making a catalytic material, the method comprising the steps of. providing a solution comprising a metal salt and an organic substrate precursor; and heating the solution under pressure to form a catalytic material; wherein the metal salt comprises a metal selected from the group consisting of cobalt, iron, chromium, copper, manganese, nickel, vanadium, zinc and combinations thereof.

In one embodiment, the method further comprises the step of contacting the solution comprising a metal salt and an organic substrate precursor with an inorganic substrate. In one embodiment, the inorganic substrate comprises a porous inorganic scaffold.

In one embodiment, the porous inorganic scaffold is any inorganic scaffold disclosed herein. In one embodiment, the step of heating the solution under pressure in the presence of the inorganic substrate results in the inorganic substrate becoming impregnated with the catalytic material. In one embodiment, the step of heating the solution under pressure in the presence of the inorganic substrate results in the catalytic material anchoring onto the inorganic substrate.

In one embodiment, the method further comprises the step of agitating the solution comprising the porous inorganic scaffold. In one embodiment, the step of agitating the solution comprising the porous inorganic scaffold effects penetration of the precursor solution into the pores of the porous inorganic scaffold.

In one embodiment, the metal salt comprises one or more of the following metals and oxidation states: Fe^{II}, Fe^{III}, Co^{II}, Co^{III}, V^{II}, V, V^{V}, Cu^{I}, Cu^{III}, Cr^{II}, Cr^{III} Cr^{I}, Ni⁰, Ni^{I}, Ni^{II}, Zn⁰, Zn^{I}, or Zn^{II}. In one embodiment, the metal salt further comprises an anionic counterion. As would be understood by one of skill in the art, the ratio of counterion to transition metal is determined by the charge of each component so as to form a neutral compound. Exemplary anionic counterions include, but are not limited to, halide anions (e.g., F⁻, Cl⁻, Br⁻, and I⁻), NO₃⁻, ClO₄⁻, OH⁻, H₂PO₄, HSO₄⁻, SO₄⁻², sulfonate anions (e.g., methanesulfonate, trifluoromethanesulfonate, p-toluenesulfonate, benzenesulfonate, 10-camphor sulfonate, naphthalene-2-sulfonate, naphthalene-1-sulfonic acid-5-sulfonate, ethan-1-sulfonic acid-2-sulfonate, and the like), and carboxylate anions (e.g., acetate, ethanoate, propanoate, benzoate, glycerate, lactate, tartrate, glycolate, and the like). In one embodiment, the counterion is nitrate (NO₃⁻). In one embodiment, the metal salt comprises cobalt nitrate, Co(NO₃)₂.

In one embodiment, the solution is an aqueous solution. In one embodiment, the concentration of the metal salt in the solution is between 0.01 M and 100 M. In one embodiment, the concentration is between 0.01 M and 1.0 M. In one embodiment, the concentration is between 0.1 M and 1 M. In one embodiment, the concentration is between 0.2 M and 0.5 M. In one embodiment, the concentration of the metal salt is about 0.25 M.

Exemplary organic substrate precursors include, but are not limited to, organic materials with abundant oxygen functionality, including but not limited to a soluble carbohydrate, an alcohol, a carboxylic acid, and combinations thereof. In one embodiment, the soluble carbohydrate is selected from the group consisting of glucose, sucrose, fructose, galactose, lactose, maltose and combinations thereof. In one embodiment, the soluble carbohydrate is glucose.

In one embodiment, the metal salt is cobalt nitrate and the organic precursor is glucose.

In one embodiment, the organic substrate precursor comprises a sugar. In one embodiment, the organic substrate precursor comprises glucose.

In one embodiment, the concentration of the organic precursor in the solution is between 0.01 M and 100 M. In one embodiment, the concentration is between 0.01 M and 1.0 M. In one embodiment, the concentration is between 0.1 M and 1 M. In one embodiment, the concentration is between 0.2 M and 0.75 M. In one embodiment, the concentration of the organic precursor is about 0.55 M.

In some embodiments, the solution is heated to a temperature greater than 100° C., greater than 120° C., greater than 140° C., greater than 160° C., greater than 180° C., greater than 200° C., greater than 220° C., greater than 240° C., or greater than 260° C. In some embodiments, the solution may be heated to a temperature of about 260° C. In one embodiment, the solution is heated under a pressure of about 14, 15, or 16 psi. In some embodiments, the step of heating the aqueous solution under pressure comprises the step of subjecting the aqueous solution to an autoclave. In some embodiments, the temperature of the system may be increased gradually, such as at a rate of 1° C./min, 2° C./min, 3° C./min, 4° C./min, 5° C./min, 6° C./min, 7° C./min, 8° C./min, 9° C./min, or 10° C./min. For example, the temperature of the system may be increased at rate of between 1 and 10° C./min or about 5° C./min. In some embodiments, once a desired temperature is reached, said desired temperature may be maintained for a period of time. For example, the maximum temperature may be held for a period of 1 h, 2 h, 3 h, 4 h, 5 h, 6 h, 7 h, 8 h, 9 h, 10 h, 11 h, 12 h, 13 h, 14 h, 15 h, 16 h, 17 h, 18 h, 19 h, or 20 h. In some embodiments, the maximum temperature of about 260° C. may be maintained for a period of about 15 h.

### Oxidation Process Systems

In one aspect, the present invention relates to an oxidation process system comprising a containerized vessel, said containerized vessel comprising a catalytic material anchored to a porous inorganic scaffold; wherein the catalytic material comprises a hexacyano metal compound; wherein the hexacyano metal compound comprises a metal selected from the group consisting of cobalt, iron, copper, manganese, nickel, and zinc; and wherein the hexacyano metal compound comprises coordinatively unsaturated metal (II)—N—C centers.

In one embodiment, the containerized vessel is selected from the group consisting of a packed bed reactor, a pressurized membrane reactor, a batch reactor, a semi-batch reactor, a pulsed bed reactor, a fixed-bed reactor, and a plug flow reactor. In one embodiment, the containerized vessel includes a means for agitation selected from the group consisting of an agitator, a baffle, an impellor and combinations thereof. In one embodiment, the system is a portable self-contained unit or incorporated into a non-portable structure.

In one embodiment, the oxidation process system can be employed to mineralize organic contaminants in an aqueous solution such as wastewater or other contaminated aqueous effluent. In one embodiment, the system further comprises an aqueous source comprising organic pollutants. In one embodiment, the aqueous source is selected from the group consisting of municipal wastewater, industrial wastewater, ground water, and surface water. In one embodiment, the system degrades the organic pollutants. In one embodiment, the aqueous source further comprises a peroxide precursor. In one embodiment, the peroxide precursor is selected from the group consisting of hydrogen peroxide, peroxymonosulfate, peroxydisulfate, peracetic acid, and percarbonate.

In some embodiments, the vessel further comprises a peroxide precursor. In one embodiment, the catalytic material effects effective activation of the peroxide precursor. In one embodiment, the peroxide precursor is selected from the group consisting of hydrogen peroxide, peroxymonosulfate, peroxydisulfate, peracetic acid, and percarbonate.

The catalytic material may be used in an advanced oxidation process (AOP). In some embodiments, an AOP system comprises the catalytic material, either in the form of suspension, immobilized in various materials including medial filters and membrane, placed between an inlet and an outlet. A flow of wastewater through the system may be controlled by a valve and the rate of flow may be monitored and varied using the valve or similar mechanism. The system may further include a monitoring device located downstream of the outlet. The catalytic material may be located in a replaceable module or may be part of a multiple modular system to facilitate maintenance of the catalytic material while maintaining constant flow and remediation of the wastewater. Additionally, multiple modules may be used in series.

The AOP requires contact of the wastewater with peroxide precursors such as hydrogen peroxide, peroxymonosulfate, peroxydisulfate, peracetic acid, percarbonate, and combinations thereof in the presence of the catalyst. The flow rate of the wastewater and amount of catalyst and peroxide precursor may be determined by the desired amount of oxidation and the composition of the wastewater.

### Oxidation Process Methods

The present invention further relates in part to An oxidation process for treating an aqueous source comprising the step of: contacting an aqueous source with a peroxide precursor in the presence of a catalytic material; wherein the catalytic material comprises hexacyano metal compound anchored onto an inorganic substrate; wherein the hexacyano metal compound comprises a metal selected from the group consisting of cobalt, iron, copper, manganese, nickel, zinc and combinations thereof, and wherein the hexacyano metal compound comprises coordinatively unsaturated metal (II)—N—C centers.

In one embodiment, the step of contacting the peroxide precursor with the aqueous solution in the presence of the catalytic material further comprises the step of breaking the peroxide bonds in the peroxide precursor; wherein the peroxide precursor is selected from the group consisting of peroxymonosulfate, peroxydisulfate, peracetic acid, percarbonic acid, percarbonate, hydrogen peroxide and combinations thereof. In one embodiment, the step of breaking the peroxide bonds in the peroxide precursor produces reactive radicals selected from the group consisting of hydroxyl radicals, sulfate radicals, acetate radicals, carbonate radicals and combinations thereof. In one embodiment, a residual peroxide concentration is less than 10 ppm.

In one embodiment, the aqueous source comprises organic pollutants. In one embodiment, the aqueous source is selected from the group consisting of municipal wastewater, industrial wastewater, ground water, and surface water. In one embodiment, the effective peroxide activation degrades the organic pollutants in the aqueous sources.

The invention is further demonstrated and exemplified in the following examples which should not be interpreted as limiting.

### Experimental Examples

Advanced oxidation processes (AOPs) have been extensively sought after as alternatives to physical wastewater treatment processes due to their capability to destroy pollutants rather than merely relocating them to other media. However, avoiding oxidation byproduct formation by completely oxidizing them into the benign end product, CO₂, has been an impossible goal to achieve in practice. Presented herein is an innovative catalytic membrane that efficiently activates peroxymonosulfate and mineralizes organic pollutants as polluted water passes through the pores of the membrane. A hydrothermal procedure is employed synthesize cobalt hexacyanocobaltate (Co—HCC) catalysts with unsaturated, atomically-isolated Co^{II}—NC catalytic sites. Catalysts are immobilized on the pore walls of a commercial ceramic ultrafiltration membrane. The high performance of Co—HCC in creating both sulfate and hydroxyl radicals as well as nanoscale confined reaction environment. The optimized catalytic membrane achieves>80% mineralization via single-pass treatment with less than a minute of reaction time for a wide variety of organic pollutants in simulated domestic and industrial wastewaters. Further highlighted are engineering options for practical application, cost effectiveness, and mechanisms behind exceptional performance based on computational simulation.

Presented herein is an innovative AOP strategy that employs a catalytic membrane to achieve not only highly efficient removal of organic pollutants but also their ultimate mineralization. The catalytic membrane consists of newly-synthesized cobalt hexacyanocobaltate (Co—HCC) catalysts, a crystal resembling the Prussian blue structure consisting of Co^{II}—N—C—Co^{III} (Simonov, A., et al., Nature 578, 256−260 (2020)), that are immobilized on the pore surface of a ceramic ultrafiltration (UF) membrane. The catalysts produce a massive amount of mixed radicals, SO₄⁻ and OH, by activating PMS (Hodges, B. C., et al., Nat. Nanotechnol. 13, 642−650 (2018)). Consequently, the membrane pores create an extremely oxidative environment under nanoscale spatial confinement (Zhang, S., et al., Environ. Sci. Technol. 54, 10868−10875 (2020); Chen, Y., et al., Angew. Chem. Int. Edit. 58, 8134-8138 (2019)) that allows efficient utilization of surface-generated radicals. Organic pollutants are mineralized to benign CO₂, instead of forming potentially harmful oxidation byproducts, as the polluted water passes through the membrane without additional energy input. The catalytic membrane is tested with synthetic wastewaters, engineering options are examined, and cost implications are discussed in order to evaluate application potential.

A heterogeneous Fenton or Fenton-like reaction is a method to produce radicals via surface reactions that activate precursor molecules such as hydrogen peroxide and persulfate that contain peroxide bonds. Peroxymonosulfate (PMS) is a uniquely appealing precursor; it can be activated to produce both OH and sulfate (SO₄⁻) radicals which can be complementary to each other in attacking a wide range of organics and leading to mineralization. PMS is also a relatively inexpensive, easy—to—transport and easy to store chemical. For PMS activation, cobalt has shown the highest activity for catalyst preparation compared to other transition metals, as Co^{II}-sites allow for an easier withdrawal of electrons from PMS together with a hemolytic cleavage of the peroxy bond to generate SO₄-radicals (Ahn, et al., Applied Catalysis B: Environmental, 2019, 241, 561−569). A portion of the SO₄·⁻ radicals then generate OH in the aqueous phase. The coordination environment of cobalt affects the electronic structure which, in turn, affects the persulfate adsorption, electron transfer mechanism, and even the reaction pathway, kinetics, and products. Previous work showed that binding cobalt to carbon or nitrogen (Li, et al. Acs Nano 2016, 10, (12), 11532-11540) can facilitate Co—to—PMS electron transfer and therefore enhance catalyst performance. It was lately revealed that anchoring cobalt centers to pyridinic nitrogen on a carbon substrate further reduces the PMS adsorption energy and optimizes local electron property toward a more efficient Fenton-like process. (Li, et al. Acs Nano 2016, 10, (12), 11532-11540; Li, et al., J Am Chem Soc 2018, 140, (39), 12469-12475; Chu, et al., Environmental Science & Technology 2021, 55, (2), 1242-1250) Unfortunately, the production of isolated “Co—N—C” units in previous work relied on random defects of carbon substrates that not only have limited number of cobalt centers (<1 atom %) (Liu, et al., Chem Sci 2016, 7, (9), 5758-5764) but hindered electron transfer property on basal structures.

Cobalt hexacyanocobaltate (termed as Co—HCC) is analogous to the Prussian blue structure with cubic framework built from Co^{II}—N—C—Co^{III} sequences.(Simonov, et al., Nature 2020, 578, (7794), 256-+) The densely coordinated “Co^{II}—N—C” units in the crystal structure made it of particular interest to be engineered to produce coordinatively unsaturated cobalt(II) sites for PMS activation. Additionally, close binding of a nanostructured catalyst to a substrate reduces the required surface energy so as to create coordinatively unsaturated metal centers either on catalyst-substrate interfaces (Fu, et al., Science 2010, 328, (5982), 1141-1144; et al., Science 2009, 325, (5948), 1670-1673) or twisted catalyst surfaces (Xi, et al., Nat Commun 2019, 10).

### Catalyst Synthesis and Characterization

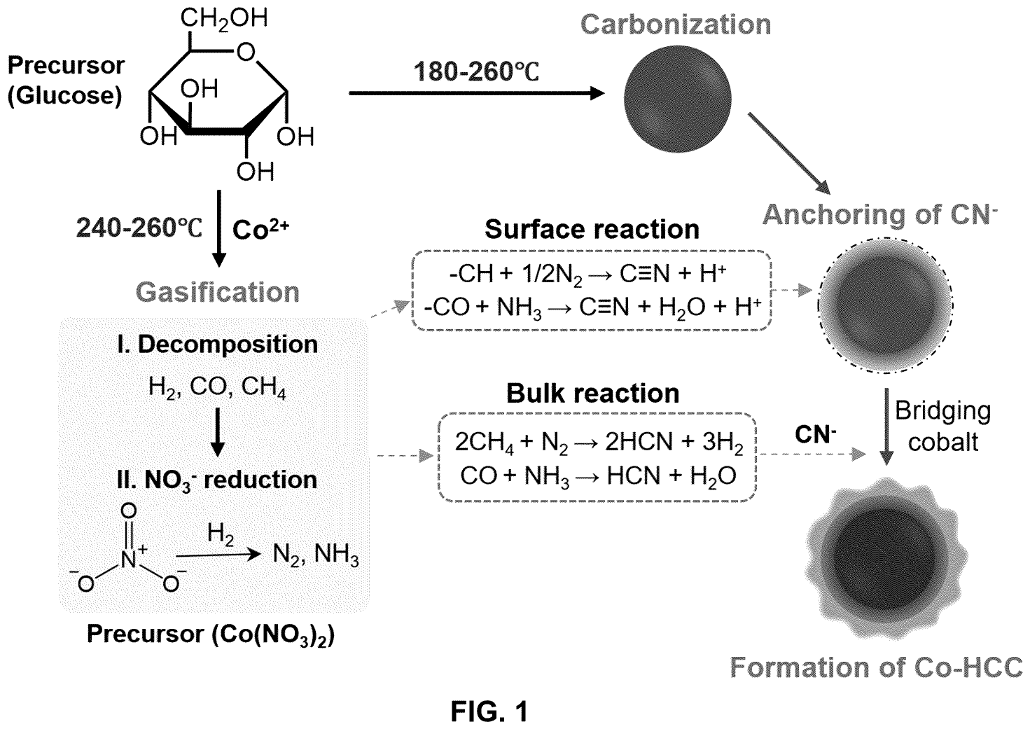

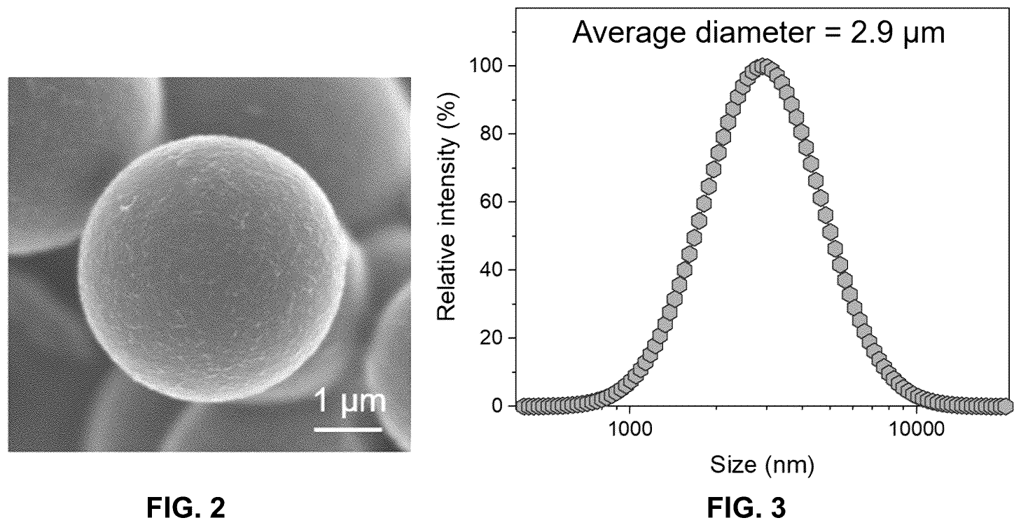

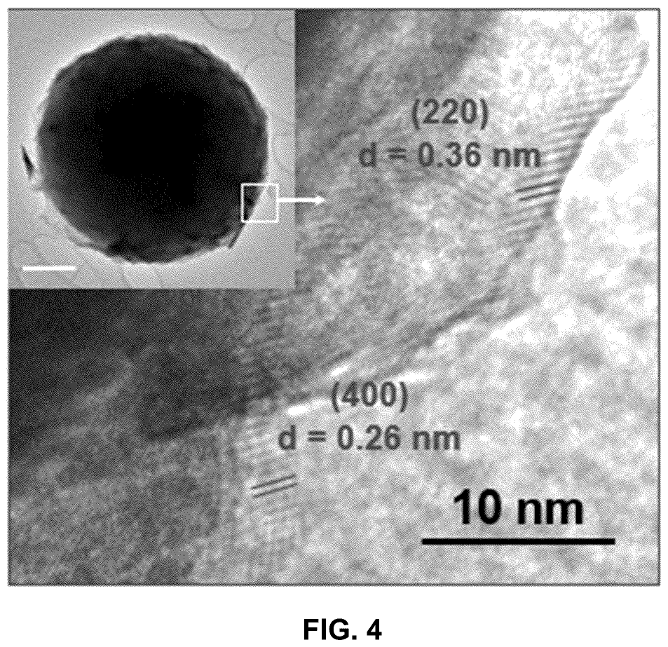

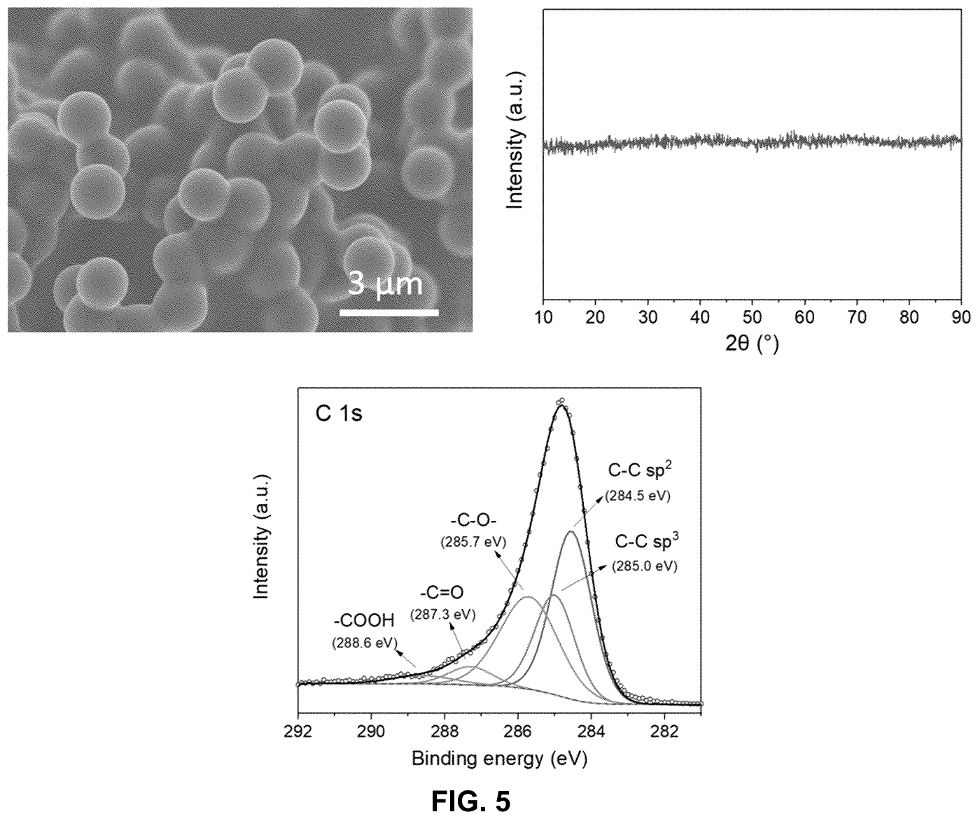

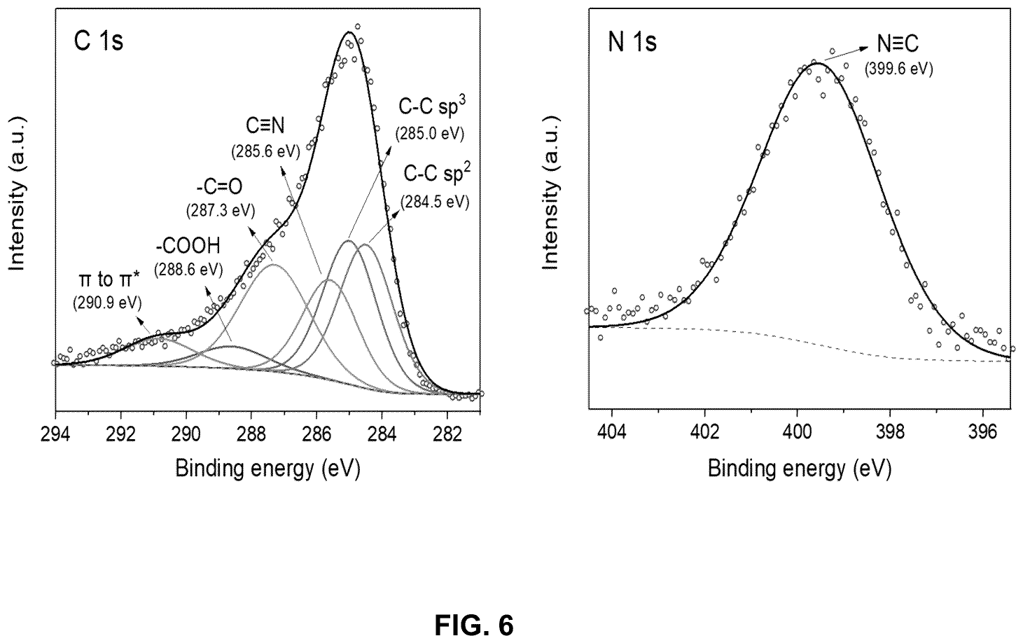

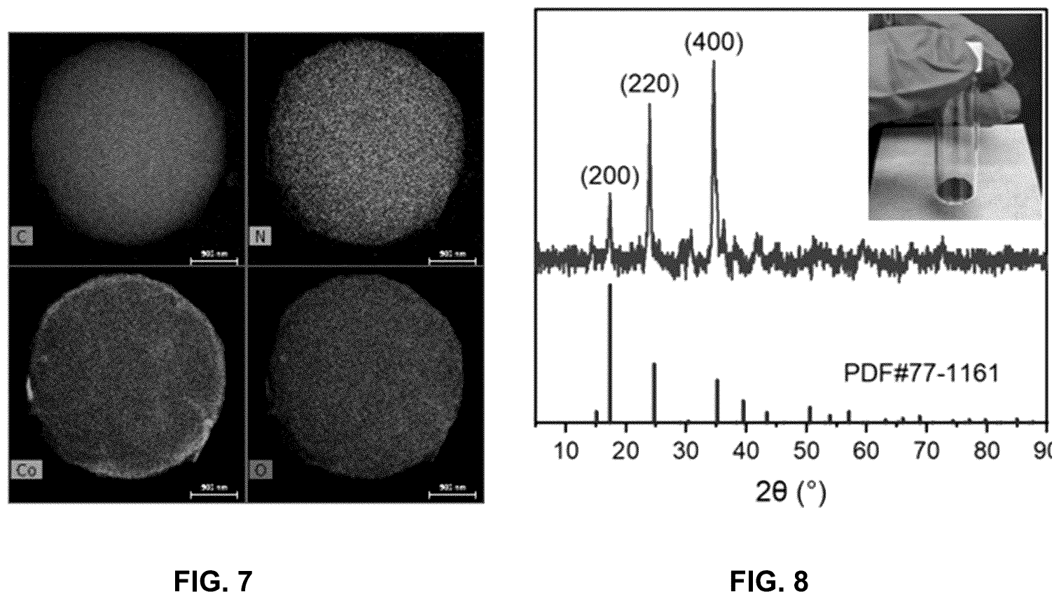

A hydrothermal synthesis procedure (FIG. 1) yielded a black powder that consists of spherical particles (FIG. 2) with a mean diameter around 3 μm (FIG. 3). Transmission electron microscopy (TEM) images suggest that these particles have core-shell structure (FIG. 4). The core consisted of amorphous carbon (FIG. 5) formed through the carbonization of glucose during the initial phase of the hydrothermal process at 180-240° C. (Romero-Anaya, A. J., et al., Carbon 68, 296-307 (2014)). During the later phase and at higher temperature (240-260° C.), glucose would gasify to H₂, CO, and CH₄²¹ and NO₃⁻ reduce to N₂ and NH₃,²² both catalyzed by Co²⁺ (Fiebig, J., Woodland, A. B., et al., Geochim. Cosmochim. Ac. 71, 3028−3039 (2007); Wang, X. Y., et al., Nat. Commun. 11: 653 (2020)). Subsequently cyanide (C-N) formed and anchored to the carbon core, consuming surface oxygen functionalities (FIG. 6, left), bridging with Co²⁺ (Zahnle, K. J. J. Geophys. Res.-Atmos. 91, 2819−2834 (1986); Holm, N. G. & Neubeck, A. Geochem. Trans. 10: 9 (2009)), and forming Co-containing shell structure (FIG. 7).

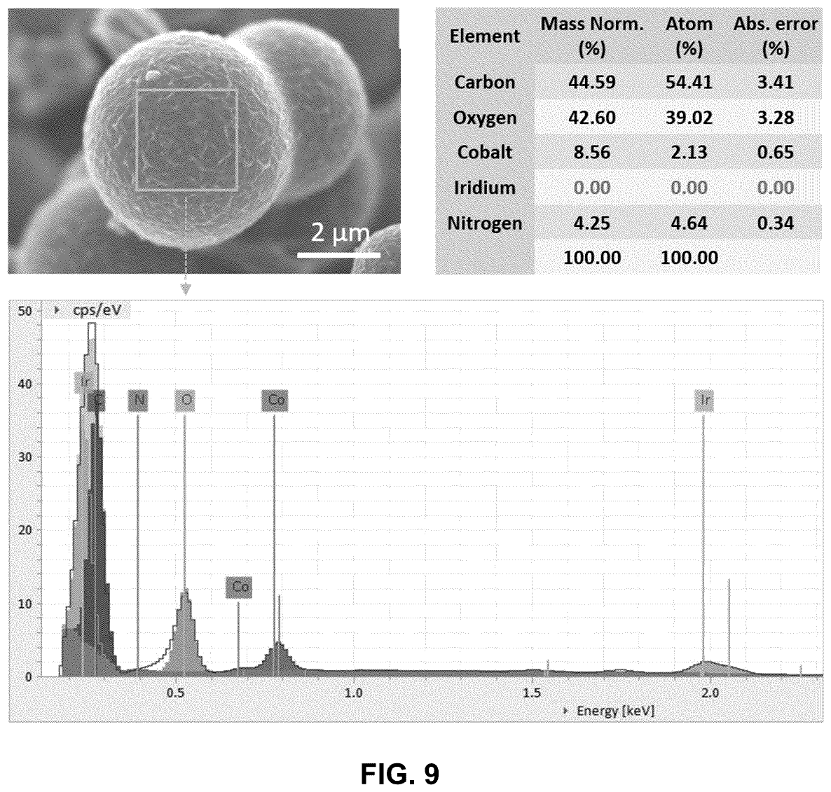

X-ray diffraction (XRD) analysis suggests the presence of a face-centered cubic crystal of Co—HCC (Co₃[Co(CN)₆]₂) with dominant (220) and (400) facets (FIG. 8). These dominant facets were found on the shell surrounding the amorphous core (FIG. 4). The C/N ratio determined by energy-dispersive X-ray spectroscopy (EDS) (FIG. 9) was 2.2, confirming Co—HCC formulation with C/N=2.4. The Co/C ratio (1/25.5) was, however, much lower than the ratio expected from the formula due to the presence of the carbon core. The anchoring of cyanide onto the carbon substrate directed the growth of Co—HCC, leading to the formation of a disordered layered structure (FIG. 4) which is different from the cubic morphology of reference cobalt hexacyanocobaltate crystal (Nie, P., et al., Nanoscale 5, 11087-11093 (2013)).

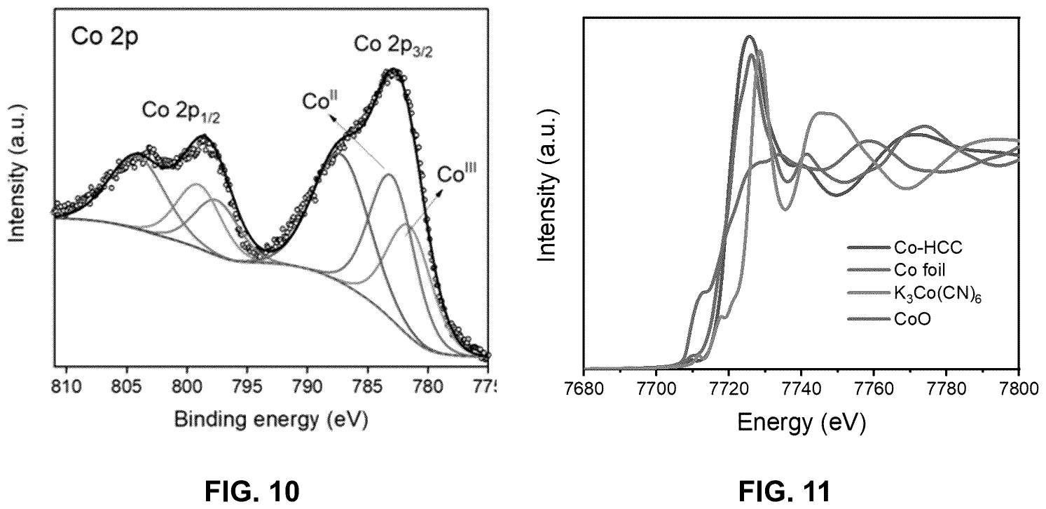

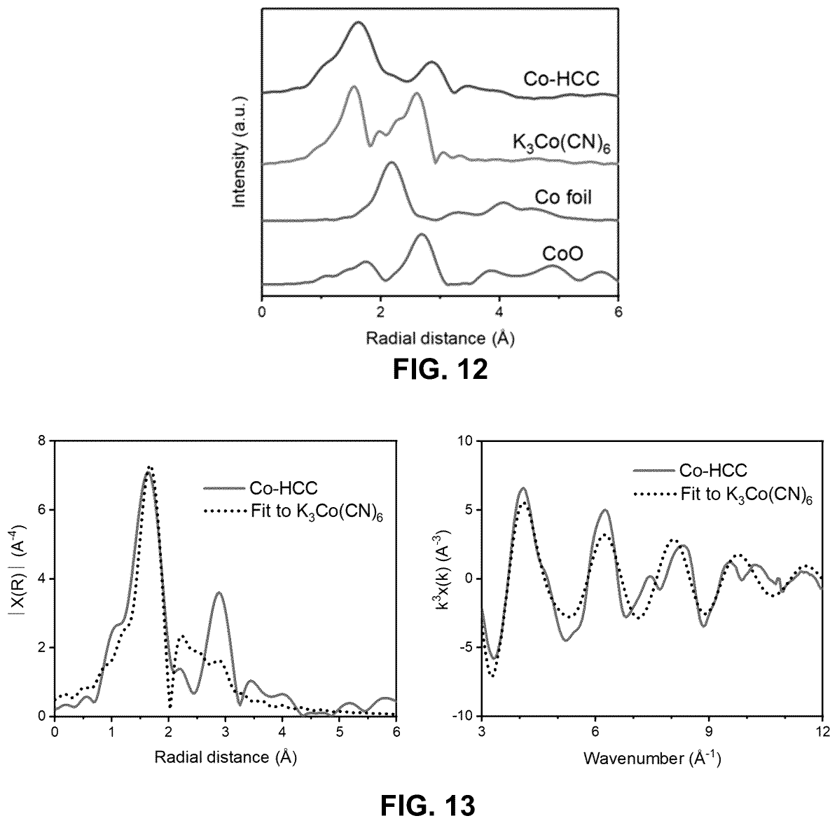

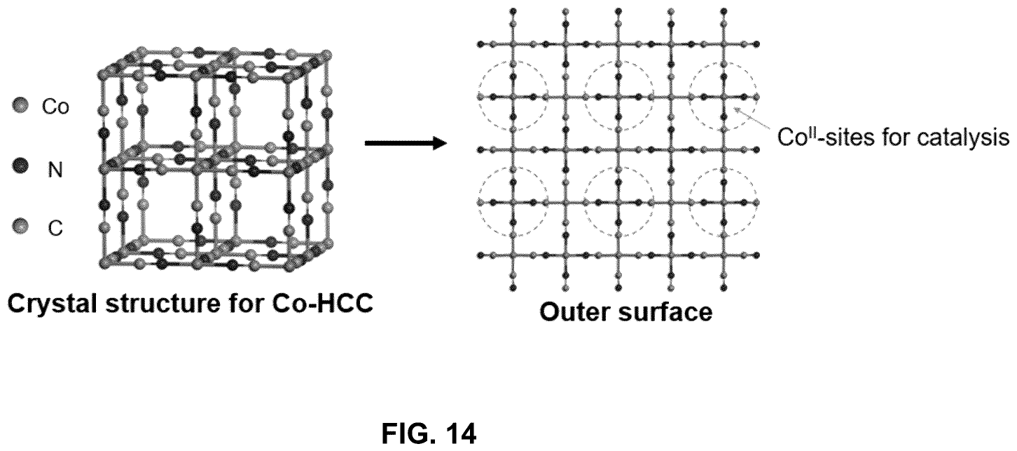

X-ray photoelectron spectroscopy (XPS, FIG. 10) and X-ray absorption near-edge spectroscopy (XANES, FIG. 11) suggest mixed-valent cobalt in Co—HCC. In-situ growth of Co—HCC led to the formation of coordinatively unsaturated Co centers (Fu, Q., et al., Science 328, 1141-1144 (2010); Kwak, J. H., et al., Science 325, 1670-1673 (2009); Xi, S. B., et al., Nat. Commun. 10: 4727 (2019)), consistent with the observation that the X-ray diffraction peak at the (200) facet (I₂₀₀/I₂₂₀=0.43) is much smaller than that of the reference (I₂₀₀/I₂₂₀=2.35) (FIG. 8). Extended X-ray absorption fine structure (EXAFS) analysis in comparison to a Co—CN reference suggests Co—N/C binding (FIG. 12). Although a spectral fitting could not be perfomed to confirm the coordination number of Co—HCC (FIG. S713 due to unresolved multiple scattering events, the evidence so far collectively suggests Co—HCC structure with Co^{II}-sites bound to N and Co^{III}-sites to C in Co^{II}—N—C—Co^{II} formation (FIG. 14).

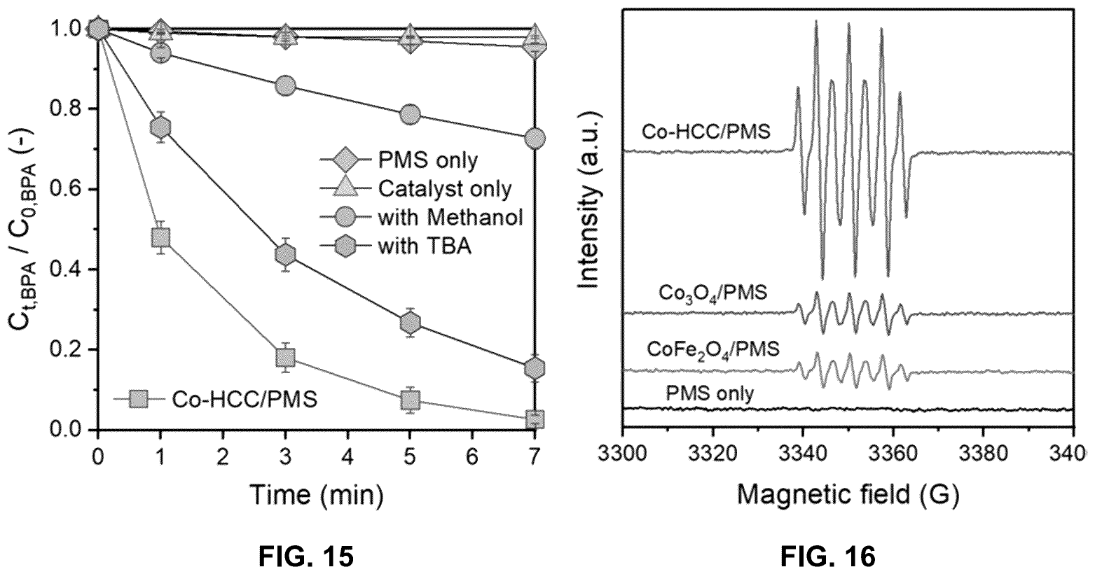

Pollutant Degradation Performance. Co—HCC in a batch suspension enabled extremely efficient PMS-based advanced oxidation. Bisphenol A (BPA) was examined as a target pollutant, considering its teratogenic and endocrine disrupting properties, massive environmental discharge (>1 million pounds per year) (U.S. Environmental Protection Agency. Bisphenol A Action Plan (2010), and ineffective removal by conventional wastewater processes (e.g., mean BPA concentration in the influent and effluent at 416 and 86 g L⁻¹, respectively) (Kasprzyk-Hordern, B., et al., Water Res. 43, 363-380 (2009)). The kinetics for parent BPA removal were too fast to be measured (i.e., nearly instantaneous BPA disappearance upon catalyst addition) when 0.05−0.5 g L⁻¹ of Co—HCC particles were added along with 0.4 mM PMS, which are within typical catalyst/PMS loading range for PMS-based AOP in the literature (Table 1). The kinetics shown in FIG. 15 (k_{obs}=0.53 min⁻¹) were therefore obtained by further lowering the Co—HCC loading down to 2.5×10⁻⁴ g L⁻¹. In contrast, neither PMS alone nor Co—HCC alone had any impact on BPA, indicating the BPA loss was primarily due to catalytic PMS activation.

TABLE 1
Pollutant degradation via cobalt-based PMS activation in this study and in reported works.

| | | | Pollutant/ | | Rate | TOF | |
|---|---|---|---|---|---|---|---|
| | | PMS | Rate constant with | pH | constant | (×10⁻⁵ mol | Ref. No. |
| Catalyst | Description | (mM) | SO₄•⁻ (M⁻¹ s⁻¹) | (—) | (min⁻¹) | g⁻¹ min⁻¹) | in FIG. 2d |
| Co-HCC | Co-HCC with preferred (400) | 0.4 | BPA (=20 μM) | 7.0 | 0.527 | 916 | This work |
| (0.00025 g L⁻¹) | facet | | k_{SO}_{₄}_{•}_{^{−}} = 1.6 × 10⁹ | | | | |
| CoP@MOF-2-C | CoP nanoparticles confined in | 0.325 | BPA (≈88 μM) | 6.7 | 18.96 | 362 | 1 ¹⁸ |
| (0.1 g L⁻¹) | N-doped yolk-shell porous carbon | | k_{SO}_{₄}_{•}_{^{−}} = 1.6 × 10⁹ | | | | |
| Co²⁺ | Homogeneous catalysis using | 0.4 | BPA (=20 μM) | 7.0 | 0.071 | 276 | This work |
| (0.00012 g L⁻¹) | cobalt cation | | k_{SO}_{₄}_{•}_{^{−}} = 1.6 × 10⁹ | | | | |
| FeCo—NC-2 | Single-Co-atom on N-doped | ≈0.65 | BPA (≈88 μM) | 6.0 | 12.52 | 239 | 2 ¹⁹ |
| (0.1 g L⁻¹) | graphene sphere | | k_{SO}_{₄}_{•}_{^{−}} = 1.6 × 10⁹ | | | | |
| Co@N—C—KNO₃ | Co nanoparticles with preferred | 1.95 | BPA (≈219 μM) | 6.8 | 0.73 | 139 | 3 ²⁰ |
| (0.025 g L⁻¹) | facet on N-doped carbon | | k_{SO}_{₄}_{•}_{^{−}} = 1.6 × 10⁹ | | | | |
| NCoHCP | Co coordinated by N | 4 | BPA (100 μM) | 6.7 | 7.8 | 85 | 4 ²¹ |
| (0.2 g L⁻¹) | in hollow carbon polyhedron | | k_{SO}_{₄}_{•}_{^{−}} = 1.6 × 10⁹ | | | | |
| CSH-80 | Cobalt silicate hydroxide in | 0.35 | RhB (≈200 μM) | 7.0 | 0.22 | 51 | 5 ²³ |
| (0.1 g L⁻¹) | hierarchical hollow nanosphere | | k_{SO}_{₄}_{•}_{^{−}} = 3.0 × 10⁸ | | | | |
| Co—NC | Zero-valent cobalt encapsulated | 1 | BPA (≈88 μM) | 6.5 | 2.4 | 30 | 6 ²⁴ |
| (0.15 g L⁻¹) | inside carbon nanotube | | k_{SO}_{₄}_{•}_{^{−}} = 1.6 × 10⁹ | | | | |
| Co-NG | Co coordinated by N | 2 | benzoic acid (50 μM) | 7.0 | 0.39 | 28 | 7 ²⁶ |
| (0.02 g L⁻¹) | in graphite | | k_{SO}_{₄}_{•}_{^{−}} = 1.2 × 10⁹ | | | | |
| Co-TPML | Co single-atom catalyst bound to | 2 | BPA (50 μM) | 3.5 | 2.2 | 12.0 | 8 ²⁷ |
| (0.2 g L⁻¹) | tetrapyridomacrocyclic ligands | | k_{SO}_{₄}_{•}_{^{−}} = 1.6 × 10⁹ | | | | |
| Fe₁Mn₅Co₄—N@C | Transition-metal nitrides | ≈0.65 | BPA (≈88 μM) | 6.0 | 0.48 | 9.2 | 9 ²⁸ |
| (0.1 g L⁻¹) | encapsulated in graphene | | k_{SO}_{₄}_{•}_{^{−}} = 1.6 × 10⁹ | | | | |
| Sₓ—CF@C | CoFe₂O₄@carbon with sulfur | ≈1.3 | 4-Nitrophenol | 6.4 | 0.126 | 6.8 | 10 ³⁰ |
| (0.14 g L⁻¹) | dopant | | (≈144 μM) | | | | |
| | | | k_{SO}_{₄}_{•}_{^{−}} = 6.6 × 10⁸ | | | | |
| CFNCS | CoFe₂O₄ nanoparticles loaded on | 0.65 | Salicylic Acid | 7.0 | 0.19 | 5.94 | 11 ³² |
| (0.05 g L⁻¹) | N-doped | | (≈72 μM) | | | | |
| | carbon sponge | | k_{SO}_{₄}_{•}_{^{−}} = 1.6 × 10⁹ | | | | |
| rGO-CoPc | Cobalt phthalocyanine-supported | 0.1 | RhB (25 μM) | NA | 1.019 | 5.9 | 12 ³³ |
| (0.5 g L⁻¹) | reduced graphene oxide | | k_{SO}_{₄}_{•}_{^{−}} = 3.0 × 10⁸ | | | | |
| Co(OH)F@MXenes | Cobalt hydroxide loaded on F- | ≈1 | BPA (≈88 μM) | 7.0 | 0.2593 | 4.95 | 13 ³⁴ |
| (0.1 g L⁻¹) | bonded MXene | | k_{SO}_{₄}_{•}_{^{−}} = 1.6 × 10⁹ | | | | |
| Co—N—C | Co single-atom catalyst anchored | 0.2 | Diatrizoate (5 μM) | 7.5 | 0.2 | 3.7 | 14 ³⁶ |
| (0.005 g L⁻¹) | on N-doped carbon | | k_{SO}_{₄}_{•}_{^{−}} = 1.9 × 10⁹ | | | | |
| Co—Bi₂₅FeO₄₀ | Cobalt doped on Bi₂₅FeO₄₀ | 3.7 | BPA (≈263 μM) | 7.0 | 0.6 | 2.9 | 15 ³⁷ |
| (1.2 g L⁻¹) | | | k_{SO}_{₄}_{•}_{^{−}} = 1.6 × 10⁹ | | | | |
| CoS₂ | Cobalt sulfide hollow nanosphere | 1.3 | Ciprofloxacin | 8.0 | 0.12 | 1.9 | 16 ³⁹ |
| (0.08 g L⁻¹) | | | (≈30 μM) | | | | |
| | | | k_{SO}_{₄}_{•}_{^{−}} = 8.4 × 10⁸ | | | | |
| CuCo₂S₄ | Spinel sulfide carrollite | 0.1 | Bisphenol S | 7.2 | 0.158 | 1.8 | 17 ⁴⁰ |
| (0.01 g L⁻¹) | | | (10 μM) | | | | |
| | | | k_{SO}_{₄}_{•}_{^{−}} = 3.1 × 10⁹ | | | | |
| CS—CoFe₂O₄ | CoFe₂O₄ encapsulated in carbon | ≈1.6 | Orange II (≈143 μM) | NA | 0.269 | 1.7 | 18 ⁴² |
| (0.1 g L⁻¹) | shell | | k_{SO}_{₄}_{•}_{^{−}} = 8.1 × 10⁹ | | | | |
| Co—N/C | Co single-atom catalyst anchored | 0.5 | Naproxen (≈43 μM) | 7.0 | 0.241 | 1.3 | 19 ⁴⁴ |
| (0.05 g L⁻¹) | on N-doped carbon | | k_{SO}_{₄}_{•}_{^{−}} = 5.6 × 10⁹ | | | | |
| Co₃O₄@NSC | Co₃O₄ embedded nitrogen and | 0.5 | Paracetamol | 5.0 | 0.247 | 1.2 | 20 ⁴⁶ |
| (0.1 g L⁻¹) | sulfur co-doped porous char | | (≈66 μM) | | | | |
| | | | k_{SO}_{₄}_{•}_{^{−}} = 4.7 × 10⁹ | | | | |
| Co₃O₄ | Mesoporous cobalt oxide with | ≈0.65 | BPA (175 μM) | 6.0 | 0.0232 | 0.882 | 21 ⁴⁷ |
| (0.1 g L⁻¹) | oxygen vacancies | | k_{SO}_{₄}_{•}_{^{−}} = 1.6 × 10⁹ | | | | |
| Mn_{0.3}Co_{2.7}S₄ | Mn-substituted hollow Co-based | ≈1 | Sulfamethazine | 6.5 | 0.363 | 0.87 | 22 ⁴⁹ |
| (0.08 g L⁻¹) | bimetallic sulfide polyhedron | | (≈200 μM) | | | | |
| | | | k_{SO}_{₄}_{•}_{^{−}} = 3.6 × 10¹⁰ | | | | |
| CoCNₓ@SBA-15 | Co and N co-doped carbon | 2.5 | Naproxen (43 μM) | 6.4 | 0.0877 | 0.62 | 23 ⁵⁰ |
| (0.0375 g L⁻¹) | composite in the pores of SBA-15 | | k_{SO}_{₄}_{•}_{^{−}} = 5.6 × 10⁹ | | | | |
| CoO@mpgCN | CoO nanoparticles loaded on | 10 | Sulfamethoxazole | 7.0 | 0.314 | 0.62 | 24 ⁵² |
| (0.1 g L⁻¹) | mesoporous carbon nitride | | (50 μM) | | | | |
| | | | k_{SO}_{₄}_{•}_{^{−}} = 8.8 × 10⁹ | | | | |
| CoFe₂O₄ | Cobalt ferrite nanoparticles | 1 | BPA (100 μM) | 6.3 | 0.0542 | 0.59 | 25 ⁵³ |
| (0.2 g L⁻¹) | | | k_{SO}_{₄}_{•}_{^{−}} = 1.6 × 10⁹ | | | | |
| Co—SiOₓ | Co-inherent silicon oxide | 3 | 2,4-Dichlorophenol | 7.0 | 0.714 | 0.41 | 26 ⁵⁵ |
| (1 g L⁻¹) | | | (122.6 μM) | | | | |
| | | | k_{SO}_{₄}_{•}_{^{−}} = 7.4 × 10⁹ | | | | |
| CoFeOCl | Iron-cobalt mixed oxychloride | 0.5 | Acetaminophen | 7.0 | 0.464 | 0.34 | 27 ⁵⁶ |
| (0.1 g L⁻¹) | nanosheet | | (10 μM) | | | | |
| | | | k_{SO}_{₄}_{•}_{^{−}} = 4.7 × 10⁹ | | | | |
| Co-BTC | Cobalt-BTC type MOF | 0.5 | Sulfamethazine | 5.5 | 0.174 | 0.24 | 28 ⁵⁷ |
| (0.05 g L⁻¹) | | | (≈72 μM) | | | | |
| | | | k_{SO}_{₄}_{•}_{^{−}} = 3.6 × 10¹⁰ | | | | |
| COCA-A | Co-doped carbon aerogel | 3.9 | Phenol (≈210 μM) | 7.5 | 0.05 | 0.21 | 29 ⁵⁹ |
| (0.2 g L⁻¹) | | | k_{SO}_{₄}_{•}_{^{−}} = 8.8 × 10⁹ | | | | |
| CoCNT | Co and CoO nanoparticles | ≈0.49 | BPA (≈22 μM) | 7.0 | 0.0815 | 0.19 | 30 ⁶⁰ |
| (0.2 g L⁻¹) | confined in N-doped carbon | | k_{SO}_{₄}_{•}_{^{−}} = 1.6 × 10⁹ | | | | |
| | nanotube | | | | | | |
| TS-Co₃O₄ | Triple-shelled Co₃O₄ hollow | ≈0.59 | Carbamazepine | 5.9 | 0.079 | 0.15 | 31 ⁶² |
| (0.2 g L⁻¹) | structure | | (≈21.2 μM) | | | | |
| | | | k_{SO}_{₄}_{•}_{^{−}} = 1.9 × 10⁹ | | | | |

¹⁸ Zhu, et al., Adv. Funct. Mater. 30: 2003947 (2020)
¹⁹ Li, X., et al., J. Am. Chem. Soc. 140, 12469-12475 (2018)
²⁰ Wu, L. P., et al., ACS Catal 11, 5532-5543 (2021)
²¹ Gao, Y. W., et al., ACS ES&T Eng. 1, 76-85 (2021)
²³ Shao, P. H., et al., Chem. Eng. J. 359, 79-87 (2019)
²⁴ Shao, S. T., et al., Rsc Adv. 12, 5236-5244 (2022)
²⁶ Li, H. C., et al., Chem. Eng. J. 403: 126395 (2021)
²⁷ Chu. C., et al., Environ. Sci. Technol. 55, 1242-1250 (2021)
²⁸ Li, X., et al., ACS Nano 10, 11532-11540 (2016)
³⁰ Zhu, H., et al., J. Hazard. Mater. 430: 128433 (2022)
³² Trang, N. H., et al., Chemosphere 267, 128906 (2021)
³³ Marinescu, et al., Chem. Eng. J. 336, 465-475 (2018)
³⁴ Wang, F., et al., Appl. Catal. B-Environ. 262: 118099 (2020)
³⁶ Xu, H. D., et al., Appl. Catal. B-Environ. 263: 118350 (2020)
³⁷ Li, S., Wu, et al., Chemosphere 288: 132558 (2022)
³⁹ Li, W. Q., et al., J. Hazard. Mater. 389: 121856 (2020)
⁴⁰ Xu, H. D., et al., Appl. Catal. B-Environ. 238, 557-567 (2018)
⁴² Zhu, K. X., et al., Chem. Commun. 56, 15189-15192 (2020)
⁴⁴ Qi, Y. F., et al., Appl. Catal. B-Environ. 286: 119910 (2021)
⁴⁶ Peng, L. J., et al., Appl. Catal. B-Environ. 282: 119484 (2021)
⁴⁷ Hu, J., et al., Chem. Eng. J. 400: 125869 (2020)
⁴⁹ Jiang, H., et al., Chem. Eng. J. 384: 123302 (2020)
⁵⁰ Hou, J. F., et al., Chem. Eng. J. 389: 124344 (2020)
⁵² Nguyen, T. B., et al., J. Hazard. Mater. 401: 123326 (2021)
⁵³ Cai. C., et al., J. Hazard. Mater. 399: 122979 (2020)
⁵⁵ Lian, Q. Y., et al., ACS Appl. Mater. Inter. 12, 57190-57206 (2020)
⁵⁶ Tan, C. Q., et al., Chem. Eng. J. 400: 125921 (2020)
⁵⁷ Wang, L. J., et al., Chemosphere 295: 133946 (2022)
⁶⁰ Nguyen, H., et al., Chemosphere 279: 130569 (2021)
⁶² Ma, Q. P., et al., J. Hazard. Mater. 427: 127890 (2022)

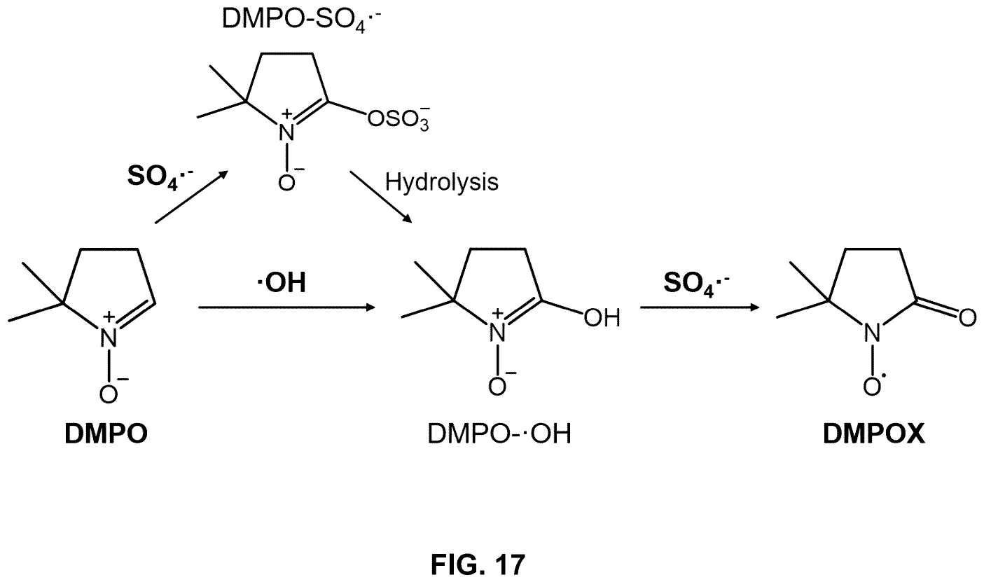

Both *OH and SO₄⁻ were generated in this system. The addition of tert-butanol alcohol (TBA) as a OH scavenger (k_{TBA/OH}≈6.0×10⁸ M⁻¹ s⁻¹) slowed down the reaction kinetics, with k_{obs} dropping by about a half to 0.27 min⁻¹ (FIG. 15). Since TBA reacts at much slower rate with SO₄⁻ (k_{TBA/SO}_{₄}≈9.3×10⁴ M⁻¹ s⁻¹) (Clifton, C. L. & Huie, R. E. Int. J. Chem. Kinet. 21, 677-687 (1989)) than OH, the rest of BPA degradation was likely driven by SO₄⁻. Upon the addition of methanol, which quenches both OH (k_{methanol/—OH}≈7.5×10⁸ M⁻¹ s⁻¹)” and SO₄⁻ (k_{methanol/SO4 ≈1.1×10}⁷ M⁻¹ s⁻¹), the performance of Co—HCC was dramatically hindered with k_{obs} reduced to merely 0.045 min⁻¹ (FIG. 15). The drastic difference between the quenching effect of TBA versus methanol confirms the involvement of SO₄⁻. Electron paramagnetic resonance (EPR) analysis was performed using 5,5-Dimethyl-1-Pyrroline-N-Oxide (DMPO) as a spin-trapping agent. EPR spectrum (FIG. 16) with a characteristic hyperfine splitting pattern of 1:2:1:2:1:2:1 (g-value=2.0066; a_{N}=7.1 G; a_{H}=4.1 G) corresponding to dimethyl-2-pyrrolidone-N-oxyl (DMPOX) confirmed the formation of SO₄⁻ and OH radicals (Chu, C. H., et al., Environ. Sci. Technol. 55, 1242-1250 (2021)) (FIG. 17 for details).

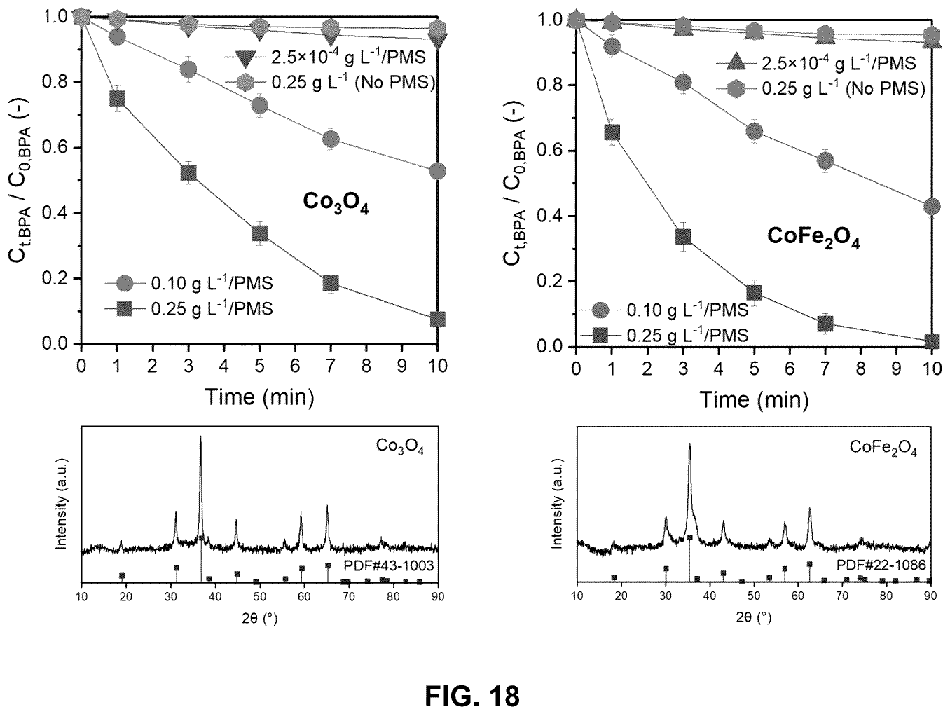

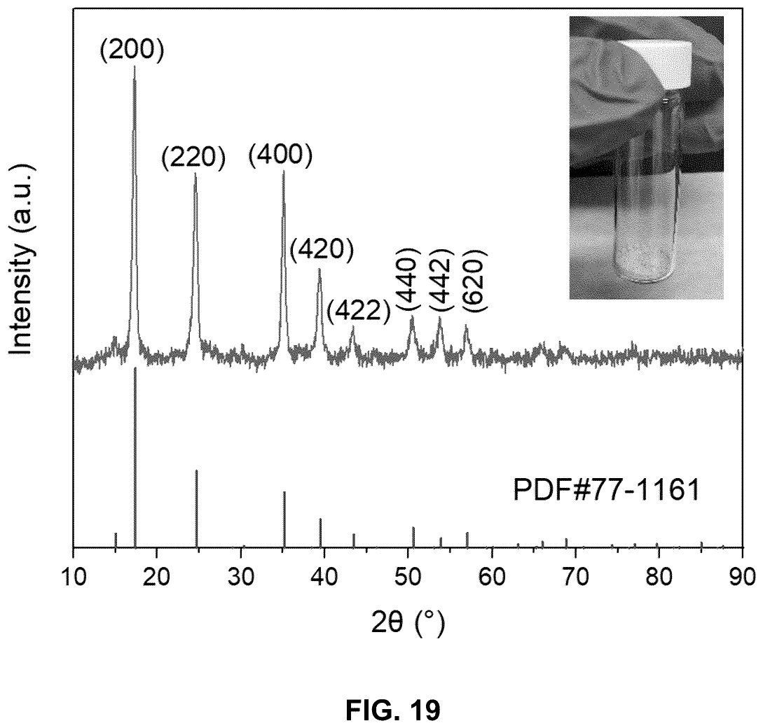

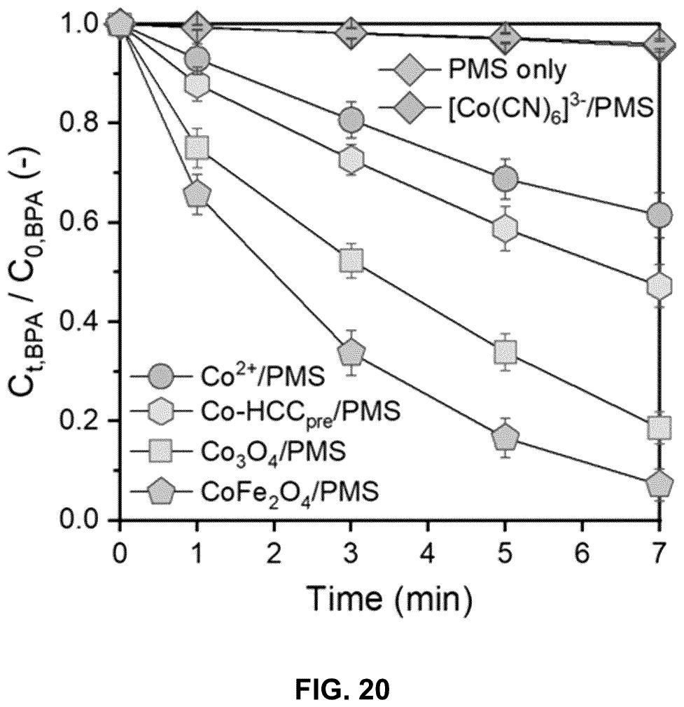

The observed BPA degradation kinetics with Co—HCC were much faster than benchmark PMS activation catalysts such as cobalt(II, III) oxide (CO₃O₄) (Anipsitakis, G. P., et al., J. Phys. Chem. B 109, 13052-13055 (2005); Chen, X. Y., et al., Appl. Catal. B-Environ. 80, 116-121 (2008); Chen, X. Y., et al., Appl. Catal. B-Environ. 80, 116-121 (2008)) and cobalt ferrite (CoFe₂O₄) (Ren, Y. M., et al., Appl. Catal. B-Environ. 165, 572-578 (2015); Yang, Q., et al., Appl. Catal. B-Environ. 88, 462-469 (2009); Li, J., et al., Chem. Eng. J. 348, 1012-1024 (2018)). As shown in FIG. 18, no catalytic effect was observed with either catalyst when added at the same dose as Co—HCC used in FIG. 15 (i.e., 2.5×10⁻⁴ g L⁻¹). Only when their loadings were increased by at least 1000 times (i.e., 0.25 g L⁻¹), reaction kinetics became comparable to that of the Co—HCC (kos(Co₃O₄)=0.25 min⁻¹; k_{obs}(CoFe₂O₄)=0.39 min⁻¹; FIG. 20). Consistently, DMPOX spectra with 20 times greater CO₃O₄ or CoFe₂O₄ loading were much weaker than Co—HCC (FIG. 16), although quantitative comparison is difficult with EPR. Unexpectedly, Co—HCC prepared by a conventional precipitation method (termed as “Co—HCCₚre” with characteristics in FIG. 19; k_{obs}=0.11 min⁻¹ with 10 times higher loading) was also much less effective than Co—HCC synthesized in this study (FIG. 20). Note that Co—HCCₚre synthesis (Qin, Z. G., et al., Adv. Health. Mater. 7: 1800347 (2018)) involved co-precipitation of metal cations (Meⁿ⁺) with hexacyanide precursor anions ([Me(CN)₆]^{m-}), thereby not allowing modulation of the unsaturated state of cobalt necessary for heterogeneous catalysis. This unexpected effect demonstrates the benefit of this supported synthesis method over the preparation of a similar, but unsupported, material.

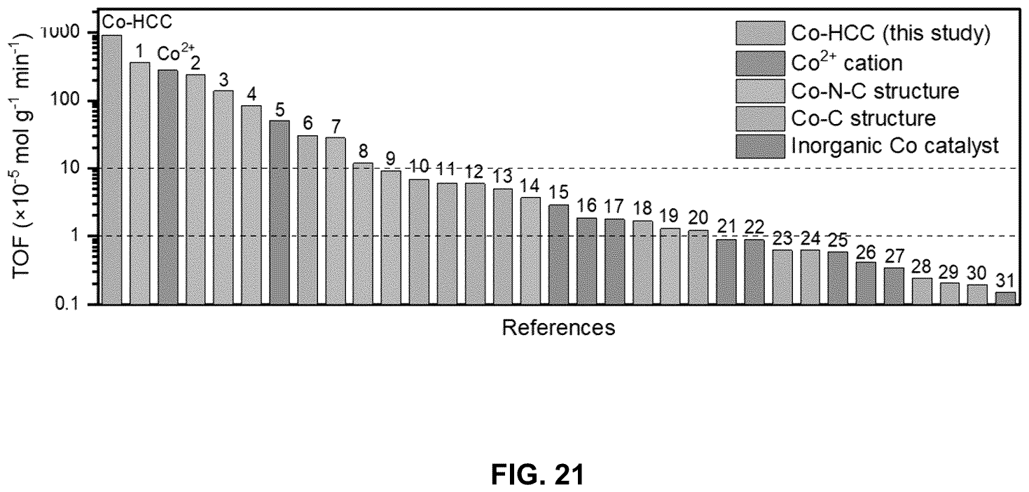

It is noteworthy that Co—HCC outperformed Co²⁺ even when normalized by the amount of Co (e.g., Co²⁺ in FIG. 20 was 8 times greater than Co in Co—HCC in FIG. 15), considering that (1) homogeneous catalysis involving free metal ions is in general faster than heterogeneous catalysis and (2) cobalt is known to be the most effective for PMS activation among transition metals (Ahn, Y. Y., et al., Appl. Catal. B-Environ. 241, 561-569 (2019)). Compared to other cobalt-based catalysts reported in the literature so far (FIG. 21), this Co—HCC catalyst demonstrated substantially better performance with the highest turnover frequency (TOF). Specifically, and unexpectedly, the TOF of Co—HCC was at least three times higher than C-N supported cobalt as the most efficient PMS activators known to date (Zhu, C. Q., et al., Adv. Funct. Mater. 30: 2003947 (2020); Li, X., et al., J. Am. Chem. Soc. 140, 12469-12475 (2018); Wu, L. P., et al., Acs Catal. 11, 5532-5543 (2021)), and was at least two orders of magnitude higher than other cobalt-based catalysts. The Co—HCC thus exhibited the highest performance for PMS activation in batch suspension.

Mechanistic Insights. The coordination environment of cobalt is likely responsible for the superior performance of Co—HCC compared to other Co-based materials (FIG. 21) (Li, X. N., et al., J. Am. Chem. Soc. 140, 12469-12475 (2018); Li, X. N., et al., ACS Nano 10, 11532-11540 (2016)). Co^{II}-sites are particularly important for electron abstraction by PMS, which triggers homolytic cleavage of the peroxy bond to generate SO₄′ (Xu, H. D., et al., Appl. Catal. B-Environ. 263: 118350 (2020)). Co bound to N—C moieties has been frequently mentioned as an effective catalytic site for this pathway, in materials such as Co bound to N-doped graphene and Co-centered porphyrins (Gong, Y. N., et al., J. Am. Chem. Soc. 142, 16723-16731 (2020); Shen, J., et al., Nat. Commun. 6: 8177 (2015)). While it is difficult to achieve high loading of Co—N—C catalytic sites with these materials (<1 Co wt %) (Liu, W. G., et al., Chem. Sci. 7, 5758-5764 (2016)), Co—HCC with repeating “Co^{II}—N—C—Co^{III}” sequences in its crystalline framework is likely provide abundant catalytic sites that are atomically isolated. Significant catalytic capability is related to abundant Co^{II}—N sites available on the surface of Co—HCC; up to 2.12 Co^{II} per nm² for (200) and (400) facets and 1.5 Co^{II} per nm² for the (220) facet, respectively.

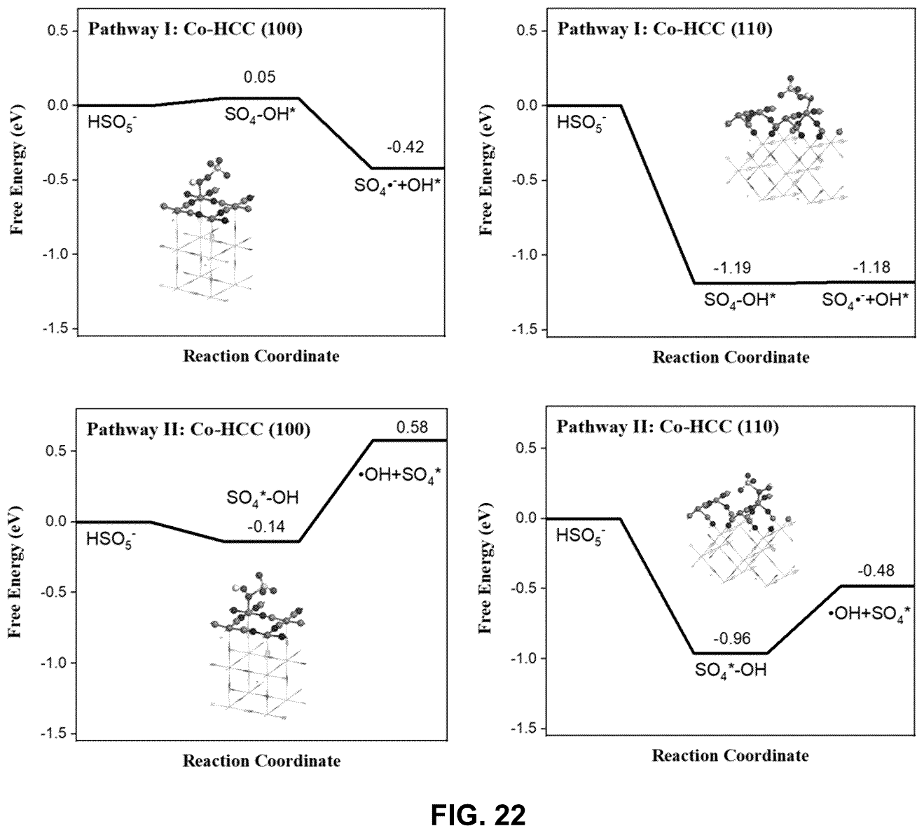

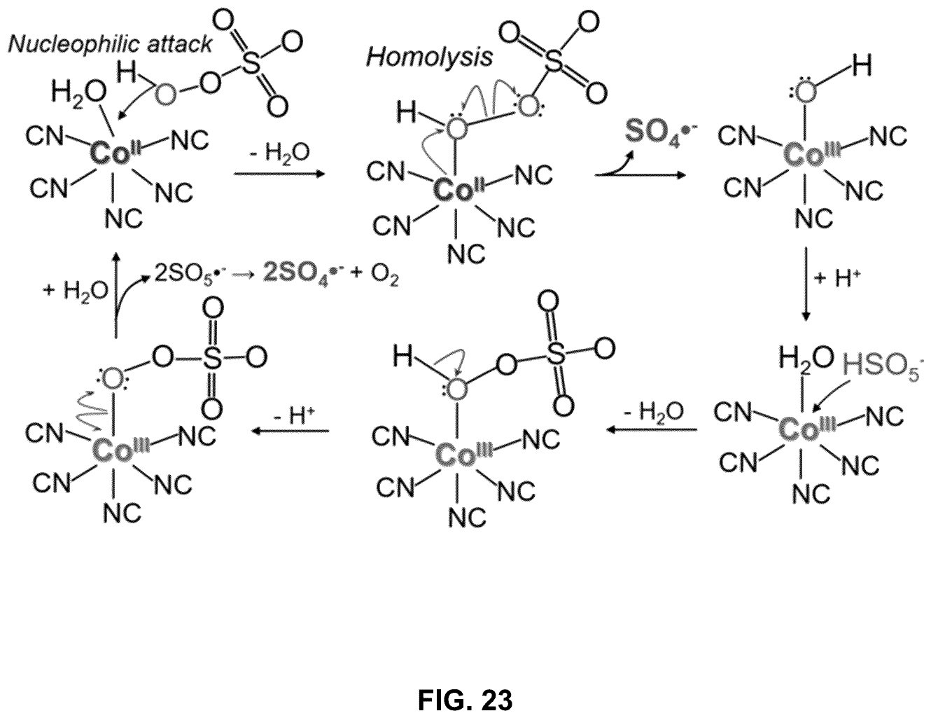

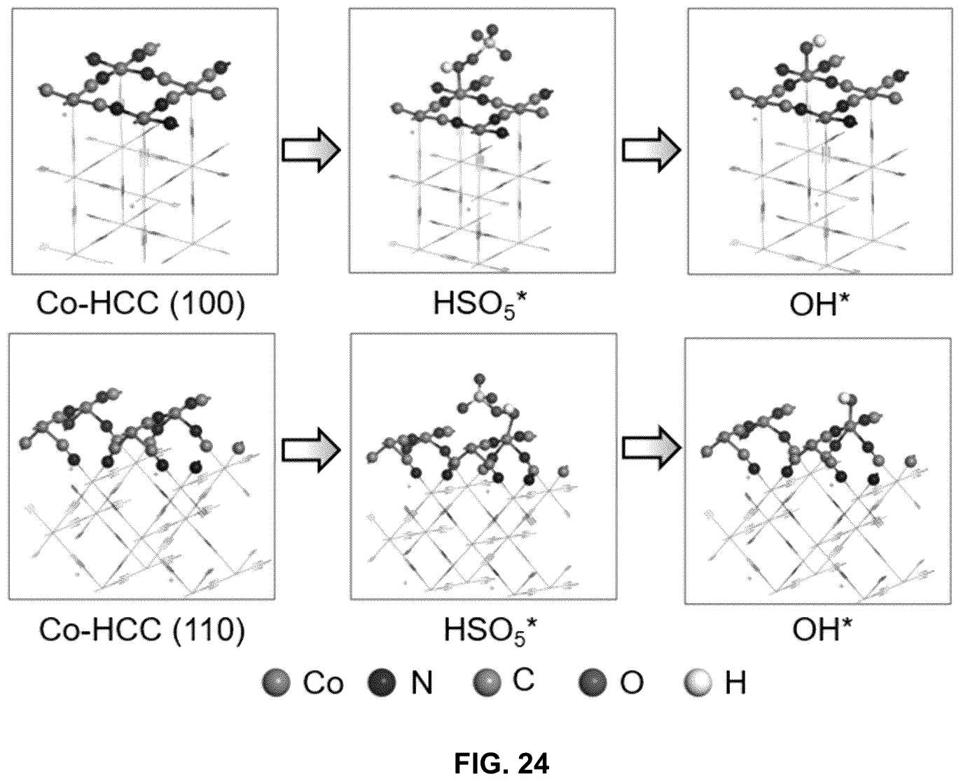

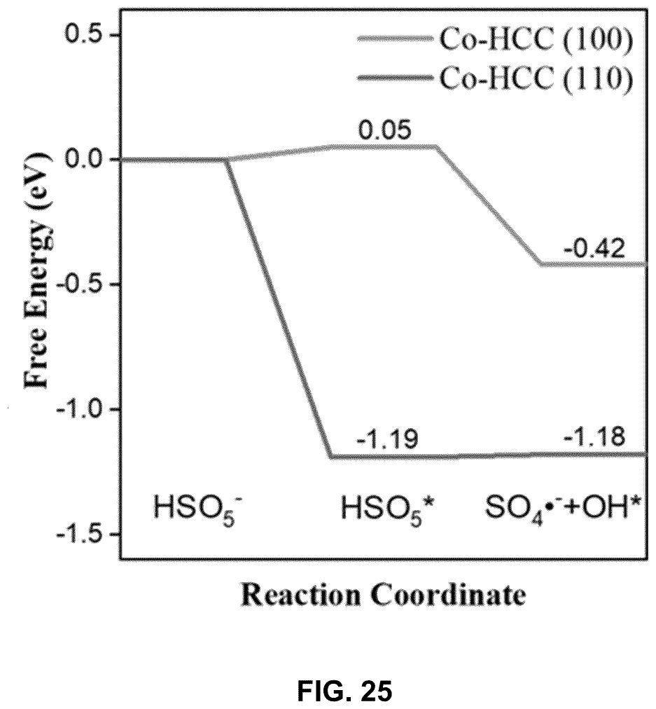

To elucidate the mechanism, Density functional theory (DFT) calculations were performed for the PMS activation on the dominant terminations of Co—HCC according to the XRD results (FIG. 21), i.e., (100) surface to represent both (200) and (400) facets, and (110) surface for the (220) facet. The two possible pathways of homolytic dissociation of the peroxy bond after the chemical adsorption of HSO₅—on Co catalytic centers were compared (Lee, J., et al., Environ. Sci. Technol. 54, 3064-3081 (2020); Hu, J. H., et al., Chem. Eng. J. 437: 135428 (2022)) i.e., direct production of SO₄⁻ (Path I, HSO₅*→SO₄⁻+OH*) versus direct production of *OH (Path II, HSO₅*→OH+SO₄*). Results of simulation suggest that the energy barrier for 0-0 bond dissociation toward Path I is negligible (<0.01 eV), whereas for Path II, the energy barrier increased up to 0.72 and 0.48 eV on (100) and (110) surfaces, respectively (FIG. 22). This implies that the direct production of SO₄⁻ is the dominant radical generation pathway, as described in FIG. 23. Furthermore, the (110) facet shows a much stronger Co-PMS binding compared to the (100) facet (FIGS. 24 and 25), indicating that the (110) facet of Co—HCC plays a dominant role in PMS activation.

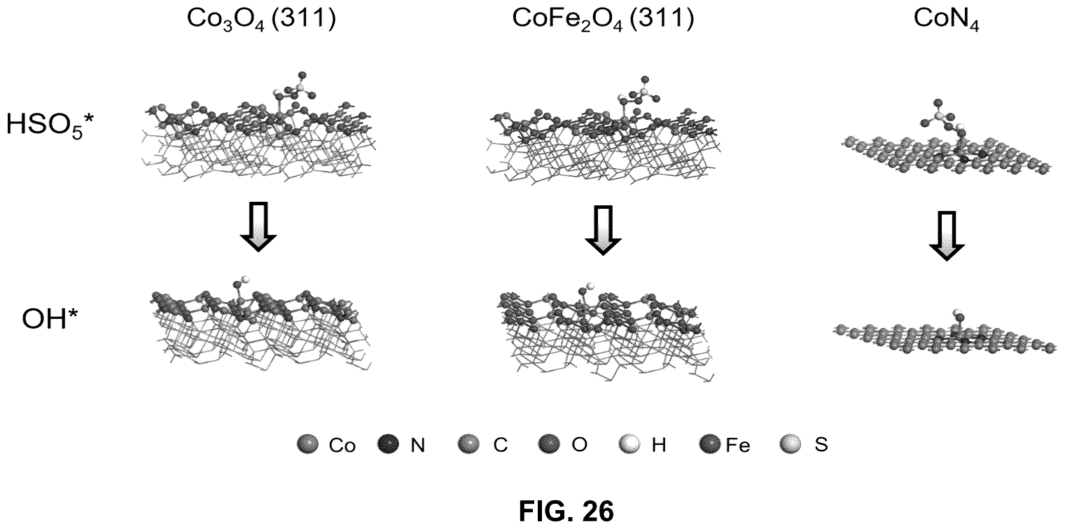

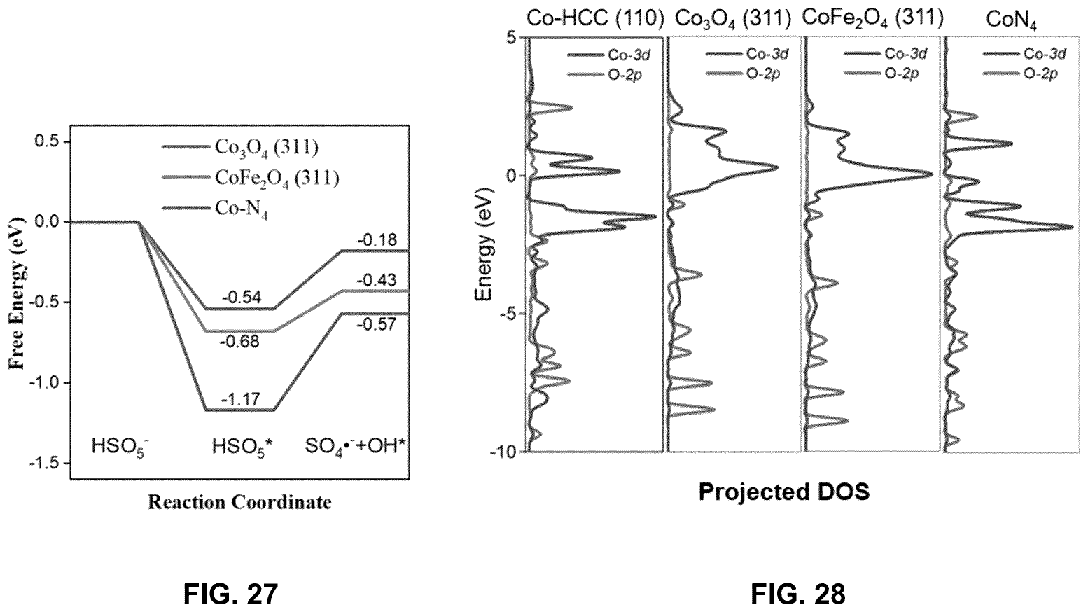

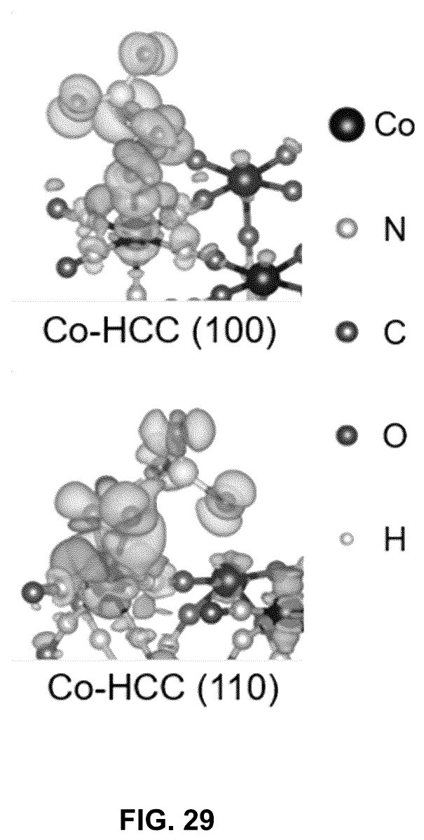

Co—HCC was compared with three other benchmark catalysts (CO₃O₄, CoFe₂O₄, and CoN₄) (relevant structures in FIG. 26). Unlike Co—HCC, the dissociation of HSO₅* is the energy-limiting step for all three catalysts, with calculated energy barriers of 0.36 eV (for the CO₃O₄ (311) facet), 0.25 eV (for the CoFe₂O₄ (311) facet), and 0.59 eV (for CoN₄), respectively (FIG. 27). The projected density of state (PDOS, FIG. 28) also showed the lowest energy level of electron interactions for Co 3d and 0 2p orbitals on Co—HCC, implying its stronger binding of Co—O on the surface as well as a preferred radical-based dissociation of HSO₅*. The charge density difference for HSO₅* adsorption on Co—HCC again demonstrated the major role of the atomically-isolated Co^{II}—NC sites to the binding and activation of PMS (FIG. 29). Results of DFT calculations collectively suggest that the unsaturated Co^{II}-sites with coordinated nitrogen are the main active centers of the Co—HCC catalyst for PMS activation. This is also consistent with our observation that Co^{III}-sites directly bonded to carbon had no catalytic effect (i.e., [Co(CN)₆]³⁻ did not cause organic degradation in PMS solution, FIG. 20).

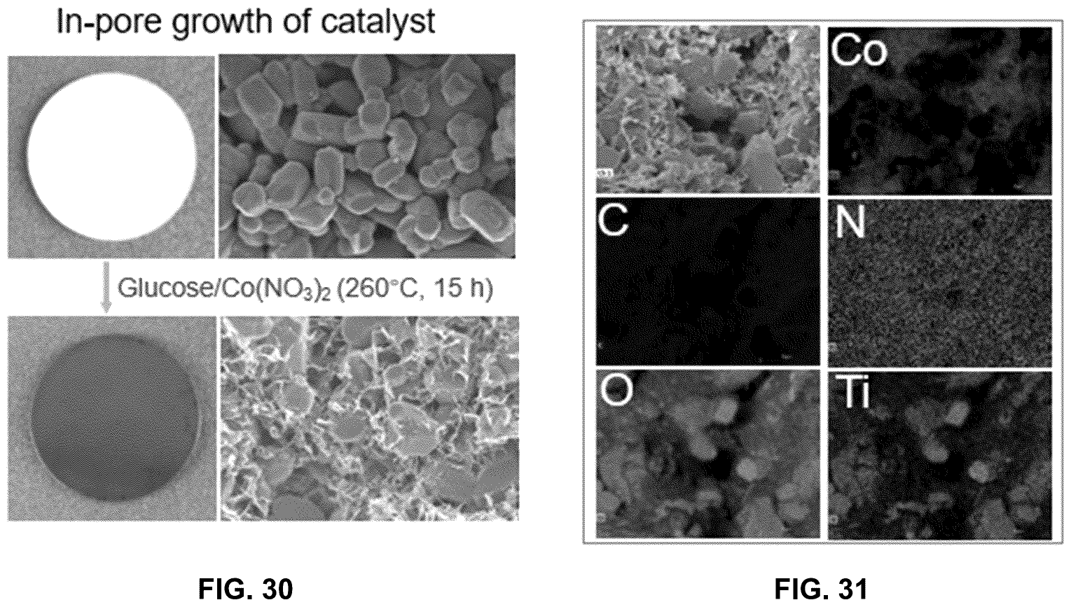

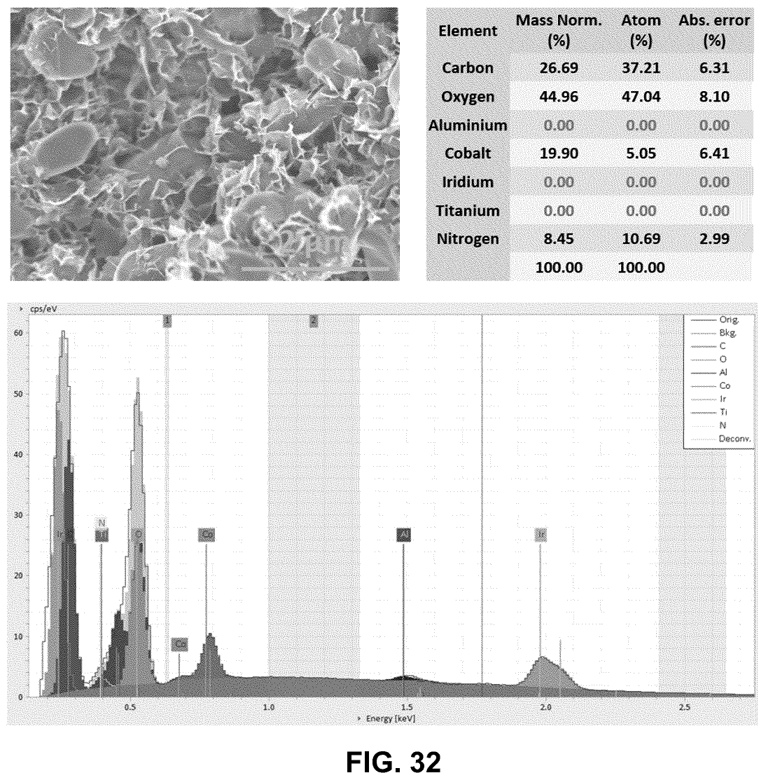

Catalytic Membrane for Mineralization. To further improve pollutant removal performance, Co—HCC was immobilized inside the nanochannels of an inorganic membrane scaffold. This nanoconfinement strategy has been particularly instrumental in enhancing surface-catalyzed advanced oxidation by maximizing the availability of both catalytic surfaces and short-lived radicals generated on the surface.¹⁷ In addition, immobilizing catalysts inside membrane pores is critical to prevent catalyst release to the environment, which would be a concern when particulate catalysts are used in suspension. A ceramic UF membrane is employed here as the scaffold (Sterlitech corporation; composition=ZrO₂ and TiO₂; pore diameter ˜20 nm; molecular weight cutoff=400 kDa, estimated by the polyethylene glycol retention method) (Howe, K. J. & Clark, M. M. Environ. Sci. Technol. 36, 3571-3576 (2002)). After in-situ growth, catalysts were deposited alongside the network of membrane channels (FIGS. 30 and 31). They appeared more elongated than the spherical particles shown previously, presumably because of the change in the morphology of carbon substrate caused by the spatial confinement during the hydrothermal synthesis. The Co/C ratio consequently decreased from 25.5 for free particles with carbon core (FIG. 9) to 7.4 (FIG. 32).

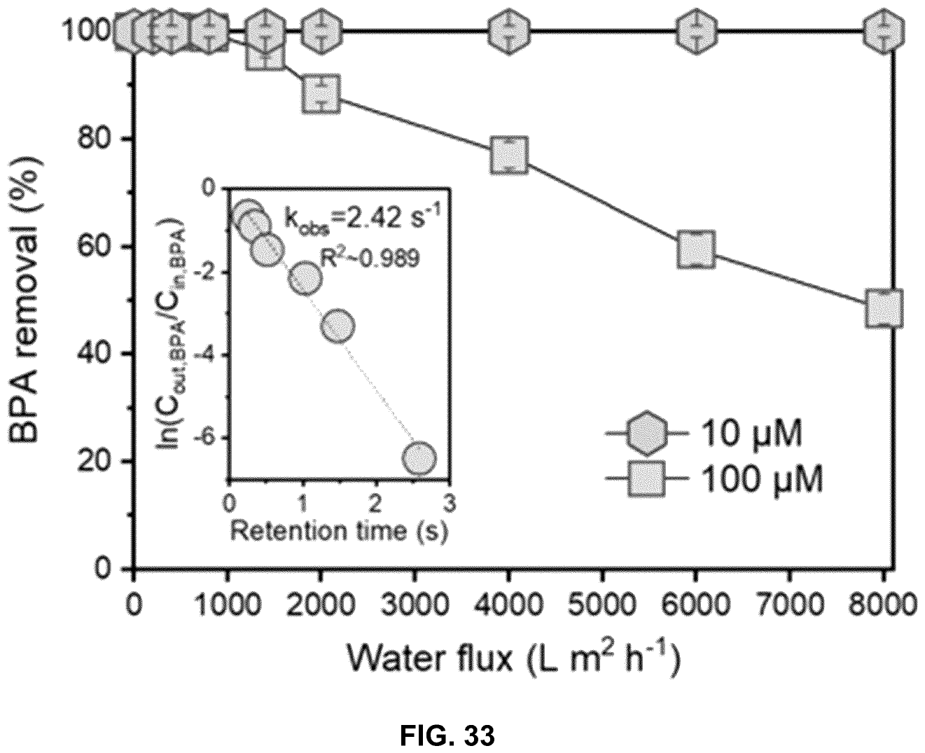

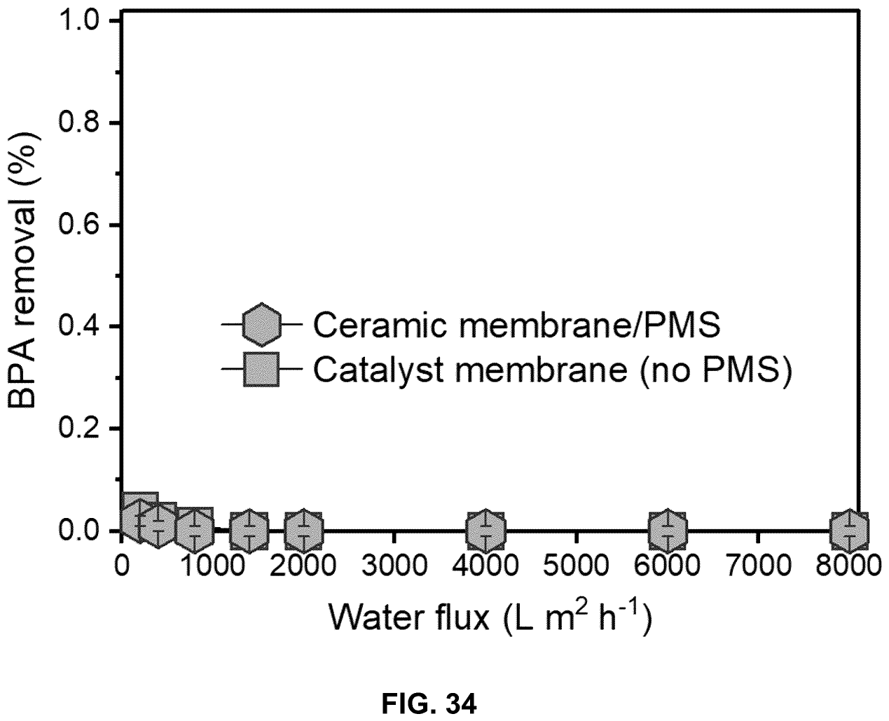

The removal of BPA was measured as the water containing BPA and PMS was passed through the membrane. Note that each data point shown in FIG. 33 corresponds to an independent flow-through experiment performed with different permeate water fluxes ranging from 200 to 8,000 L m⁻² h⁻¹ (LMH). Greater permeate flux here corresponds to shorter retention time within the pore (FIG. 33 inset), and the retention time is conceptually equivalent to the reaction time in a batch reaction (i.e., using suspension catalysts). The Co—HCC loaded membrane completely degraded 10 M of BPA (equivalent to 2280 g L⁻¹) at flux up to 8000 LMH (transmembrane pressure=2.1 bar). Note that this flux is much higher than that commonly used in UF water treatment (<500 LMH). This alternatively means that complete removal was achieved within 0.26 s of exposure to an AOP environment (i.e., SO₄⁻ and OH produced from PMS activation by Co—HCC catalyst inside the membrane pores). Under this condition, only a very small fraction of PMS (˜0.1 mM) was consumed. Even at higher BPA concentrations of 100 μM, the membrane still achieved very rapid BPA removal (FIG. 33) with a BPA half-life of only 0.29 s. As a comparison, the bare ceramic membrane with PMS did not remove BPA by size exclusion, and adsorption to the membrane was also negligible (FIG. 34).

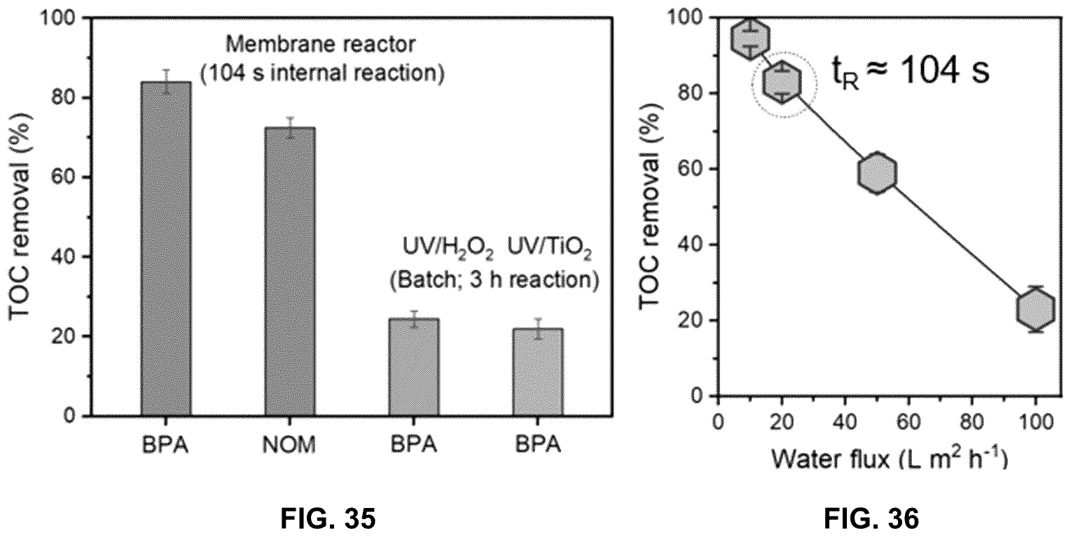

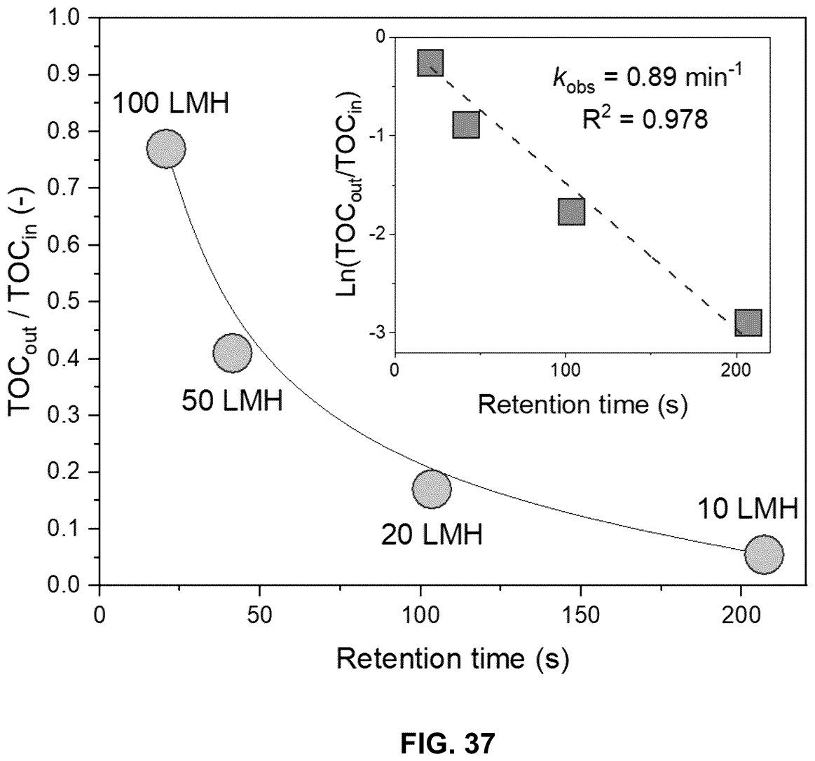

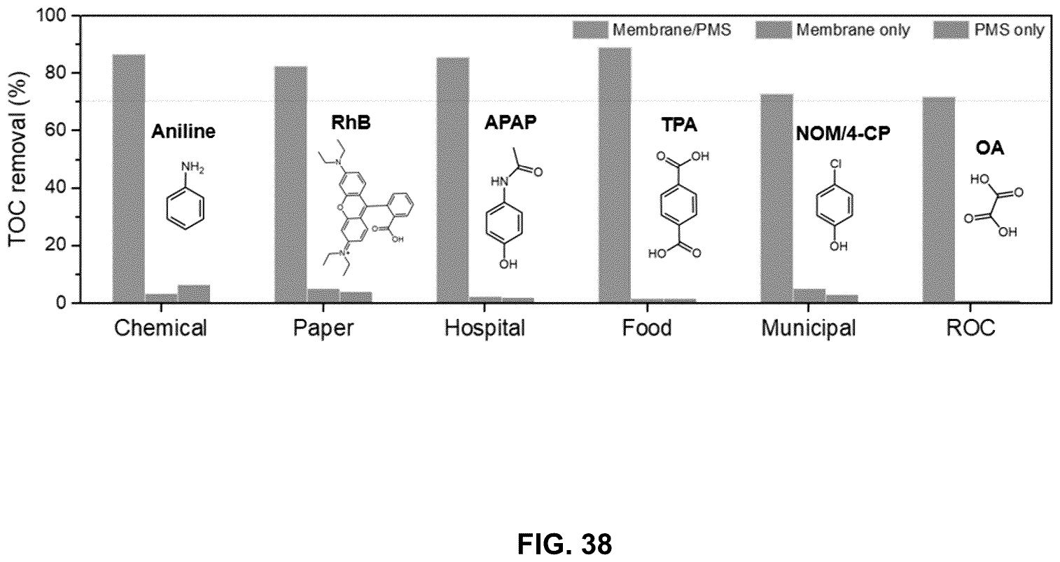

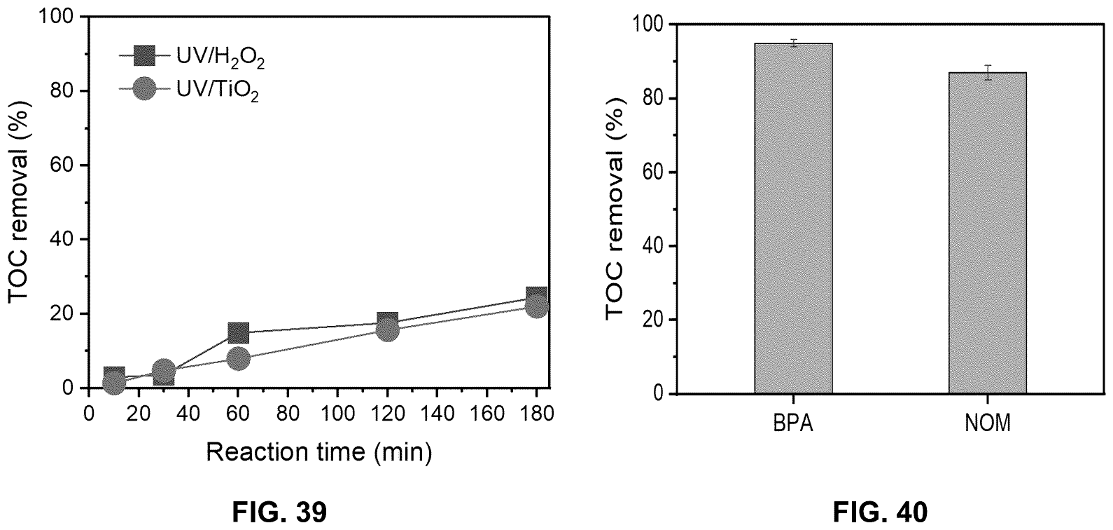

The Co—HCC loaded membrane could not only oxidize BPA (i.e., parent compound oxidation leading to various oxidation byproducts), but also mineralize BPA to CO₂. The catalytic membrane achieved ˜80% TOC removal (initial TOC ˜108 mg-C L⁻¹ from 0.6 mM BPA) by lowering the flux down to 20 LMH, equivalent to a reaction time of 104 s (FIG. 35). TOC reduction was obtained as a function of reaction time by varying the flux (FIG. 36) to obtain a pseudo-first order rate constant (FIG. 37). This empirical rate constant of mineralization (0.44 min⁻¹, R²>0.97) was higher than kinetics reported in literature for the removal of various compounds measured in terms of parent compound removal (Table 1). Such a fast mineralization rate (≈49 mg-C L⁻¹ min⁻¹) is not possible with conventional batch-mode AOPs systems (FIG. 38). As an example for comparison, benchmark photocatalytic UV/H₂O₂ and UV/TiO₂ AOPs were performed and only 21-25% removal of TOC was obtained even after 3 h of operation (FIGS. 35 and 39). The Co—HCC loaded membrane was also able to mineralize natural organic matter, which is considered difficult to oxidize due to its oxygen-rich nature (e.g., conventional AOPs even with extensive energy consumption achieve less than 55% removal) (Matilainen, A. & Sillanpaa, M. Chemosphere 80, 351-365 (2010)). Under 20 LMH, over 70% mineralization of NOM (FIG. 35 was observed with the initial concentration of 100 mg L⁻¹ (54 mg-C L⁻¹ TOC), which is much higher than that commonly observed in industrial and municipal wastewater effluents (6.4-42.3 mgC L⁻¹) (U.S. Environmental Protection Agency. Water Pollutant Loading Tool. (2021).

Application potential and engineering consideration. We obtained even higher TOC removal by placing two membranes in series, while keeping the same water flux at 20 LMH. In this configuration, TOC removal reached up to 94˜96% for water containing concentrated BPA, attaining near complete mineralization. TOC removal of NOM-containing water also reached up to 85˜89% (FIG. 40). This in-series configuration is similar to two-pass systems used in reverse osmosis operation for higher quality freshwater production from saline water desalination. Placing two membranes in a series in our case is conceptually equivalent to extending the retention time inside membrane pores. Alternatively, similar efficiency enhancement could be achieved by further lowering the flux down to 10 LMH (FIG. 36). The same water production rate can be maintained by increasing the membrane surface area in this operating option. Collectively, this configuration and operational variation demonstrates the versatility of performing AOP in a flow-through mode using catalytic membrane.

The Co—HCC membrane can be applied to a wide range of water types including simulated wastewater from select industries (chemical, hospital, paper, and food), secondary effluent of municipal wastewater treatment plant, as well as reverse osmosis concentrate (ROC) from municipal wastewater reclamation. These waters were prepared to contain most typical inorganic constituents (Tables 2, 3, and 4) as well as dominant organic contaminants that constitute the target TOC (90-110 mg-C L⁻¹), which represent pollutants that are difficult to remove by traditional biological, physical, and chemical processes. Using two catalytic membranes in series at a flux of 10 LMH, we achieved over 80% TOC removal for industrial wastewaters and over 70% TOC removal for municipal and ROC wastewaters (FIG. 38).

TABLE 2
Top wastewater pollutants of food, paper, chemical,
and hospital industries (reported in lbs).^{a}

| Food | Paper | Chemical | Health Services |
|---|---|---|---|
| Chloride | Sulfate | Chloride | Ammonia |
| (1001 mil) | (240 mil) | (75,900 mil) | (7 mil) |
| Ammonia | Chloride | Sulfate | Phosphorus |
| (203 mil) | (17 mil) | (429 mil) | (48,000) |
| Potassium | Ammonia | Fluoride | Iron |
| (138 mil) | (7 mil) | (10 mil) | (40,000) |
| Sulfate | Phosphorus | Ammonia | Chloride |
| (75 mil) | (3 mil) | (6 mil) | (20,000) |
| Sodium | Aluminum | Phosphorus | Nitrate |
| (32 mil) | (406,000) | (5 mil) | (1100) |
| Bicarbonate | Nitrate | Aluminum | Bromide |
| (28 mil) | (148,000) | (4 mil) | (129) |
| Phosphorus | Iron | Sodium | Zinc |
| (12 mil) | (127,000) | (3 mil) | (110) |
| Nitrate | Sulfite | Nitrate | Copper |
| (5 mil) | (73,000) | (2 mil) | (36) |
| Magnesium | Zinc | Iron | Aluminum |
| (4 mil) | (65,000) | (1 mil) | (20) |
| Iron | Magnesium | Bicarbonate | Manganese |
| (269,000) | (32,000) | (401,000) | (8) |

^{a}Most abundant pollutants in 2020 for select manufacturing industries. All data was compiled from the EPA Water Pollutant Loading Tool database (last accessed Nov. 18, 2021). Industries were classified by their Standard Industrial Classification code (20-Food, 26-Paper, 28-Chemical, 80-Health services). Note that ‘mil’ = million. Only pollutants that are clearly described were considered for selection (see Excel file in the Supporting Information for the full extended list). Thus, descriptors that do not specify a particular species (i.e., COD, BOD, TDS) are not included. Note the relative dominance of chloride and sulfate in these industrial effluents.

TABLE 3
Top wastewater pollutants of municipal
and ROC wastewater (reported in lbs).^{a}

| Municipal | ROC |
|---|---|
| Ammonia (4051 mil) | Bicarbonate |
| Chloride (1343 mil) | Chloride |
| Sulfate (808 mil) | Sulfate |
| Phosphorus (304 mil) | Nitrate |
| Bicarbonate (240 mil) | Bromide |
| Sodium (218 mil) | Sodium |
| Silica (107 mil) | Calcium |
| Nitrate (77 mil) | Magnesium |
| Magnesium (32 mil) | Ammonia |
| Potassium (16 mil) | Phosphate |
| | Potassium |
| | Iron |

^{a}Most abundant pollutants in 2020 for municipal and reverse osmosis concentrate (ROC) wastewater. Data for municipal wastewater was compiled from the EPA Water Pollutant Loading Tool database (last accessed Nov. 18, 2021). Note that ‘mil’ = million.

TABLE 4
Details of the as-synthesized wastewater samples for testing.^{a}

| Municipal | | Food | | Paper | |
|---|---|---|---|---|---|
| | (mg | | (mg | | (mg |
| Constituent | L⁻¹) | Constituent | L⁻¹) | Constituent | L⁻¹) |
| NaCl | 165 | NaCl | 82 | NaCl | 66 |
| Na₂SO₄ | 80 | Na₂SO₄ | 121 | Na₂SO₄ | 630 |
| NaHCO₃ | 289 | NaHCO₃ | 413 | Na₂HPO₄ | 0.5 |
| Na₂HPO₄ | 1.4 | Na₂HPO₄ | 1.1 | NH₄Cl | 2.0 |
| NH₄Cl | 0.65 | NH₄Cl | 1.5 | Na₂SO₃ | 7.0 |
| NaNO₃ | 6.2 | NaNO₃ | 1.2 | ZnCl₂ | 0.5 |
| MgSO₄ | 30.8 | KCl | 317 | FeCl₂ | 1.4 |
| KCl | 14.4 | MgCl₂ | 51 | AlNO₃ | 5.6 |
| Silica (SiO₂) | 1.0 | FeCl₂ | 1.1 | | |

| Chemical | | Health Services | | ROC | |
|---|---|---|---|---|---|
| | (mg | | (mg | | (mg |
| Constituent | L⁻¹) | Constituent | L⁻¹) | Constituent | L⁻¹) |
| NaCl | 150 | NaCl | 400 | NaCl | 1053 |
| Na₂SO₄ | 135 | Na₂HPO₄ | 2.0 | Na₂SO₄ | 500 |
| NaHCO₃ | 410 | NH₄Cl | 1.7 | NaHCO₃ | 1300 |
| Na₂HPO₄ | 1.4 | NaNO₃ | 17 | Na₂HPO₄ | 18 |
| NH₄Cl | 1.4 | NaBr | 0.5 | NH₄HCO₃ | 262 |
| NaF | 3.6 | FeCl₂ | 1.0 | NaBr | 2.7 |
| AlNO₃ | 5.6 | MnCl₂ | 0.5 | NaNO₃ | 18 |
| FeCl₂ | 2.2 | CuCl₂ | 0.5 | KCl | 151 |
| | | ZnCl₂ | 0.5 | MgCl₂ | 131 |
| | | AlCl₃ | 0.5 | CaCl₂ | 358 |
| | | | | FeCl₂ | 1.2 |

^{a}The solutions were chosen to represent model wastewaters to evaluate the effects of common industrial effluent species on membrane performance. For each constituent, the median concentrations from the DMR analyses and the ROC literature review were employed as reference values to predict which are more likely to be present at higher levels. Phosphate was used as a proxy species for phosphorus in the synthesized ROC wastewater. NaH₂PO₄ and NaHCO₃ were chosen to represent phosphate and bicarbonate as they are expected to be prevalent at the reported pH levels of these effluents in the synthesized Chemical and Health Services wastewaters.

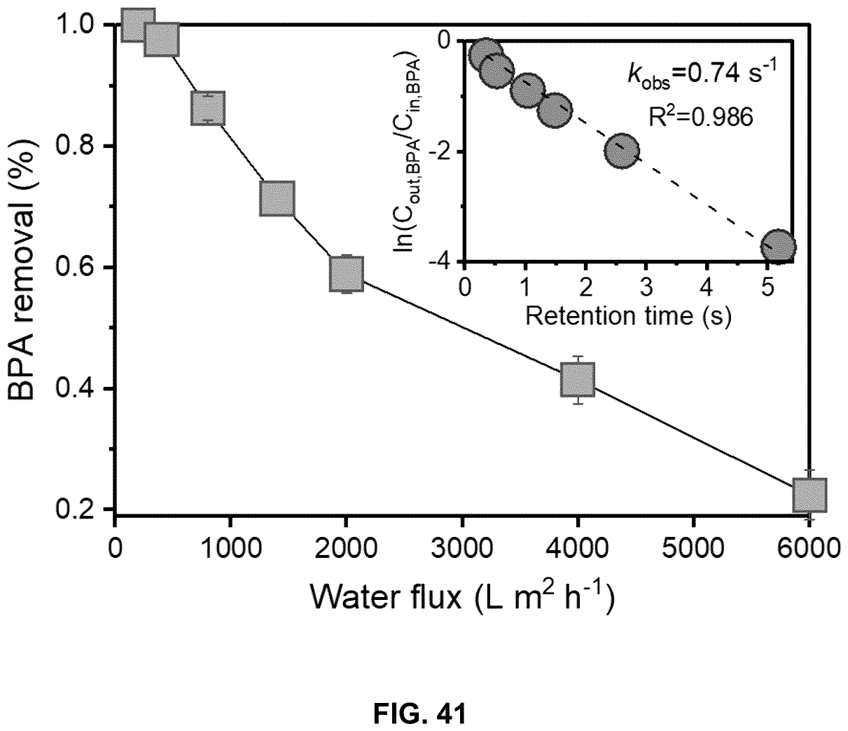

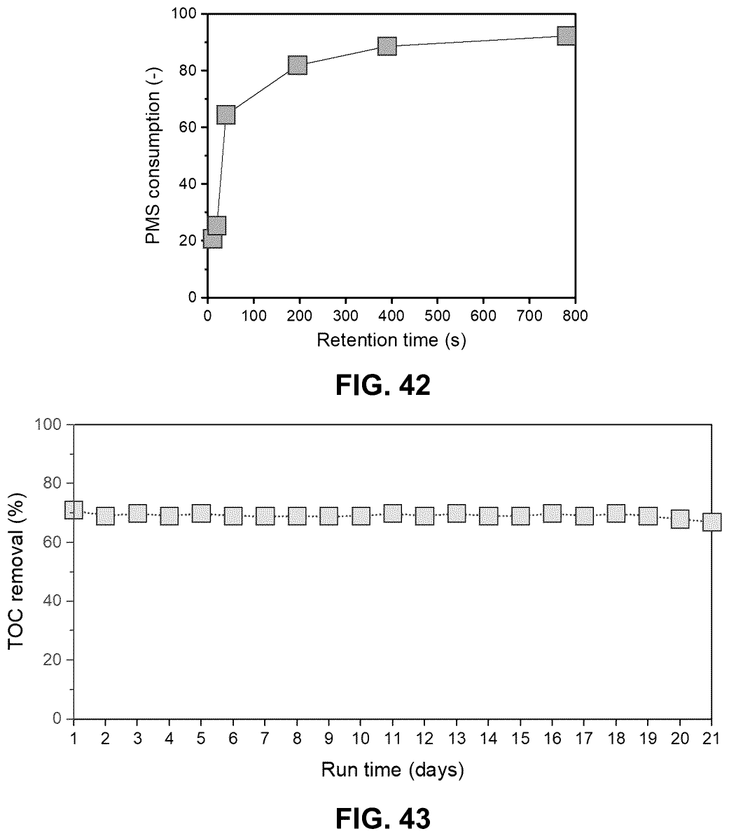

The high efficiency with ROC is particularly noteworthy, since ROC contains high concentrations of Cl⁻ (640 mg L⁻¹) and HCO₃⁻ (950 mg L⁻¹) that can quench radicals (k_{cl-/SO}_{₄}₋=4.7×10⁸ M⁻¹ s⁻¹;⁵⁶ k_{HCO}_{₃}_{/SO}_{₄}−=9.1×10⁶ M⁻¹ s⁻¹;⁵⁷ k_{HCO}_{₃}_{-/OH}≈8.5×10⁶ M⁻¹ s^{-1 58}) The results suggest an extremely high radical production rate of 8.8×10⁻³ M s⁻¹, which enables overcoming the quenching effects by Cl⁻ and HCO₃⁻ (3.9×10⁴M s⁻¹) (FIG. 41). This radical production is accompanied by the rapid consumption of PMS. About 65% of PMS was consumed during the initial 39 s (FIG. 42 for details), leaving only 35% of PMS available for the rest of retention time (350 μs) when the flux was 10 LMH. This makes the initial PMS dose another parameter to control to further enhance the AOP performance, as long as sulfate, the product of PMS activation, is not a concern to the product water quality (Zachara, J. M., et al., Geochim. Cosmochim. Ac. 181, 144-163 (2016)).

The Co—HCC membrane maintained its performance over 3 weeks without deactivation (FIG. 43), which is substantially longer than that of previously reported PMS catalysts. Both cobalt-based (Shi, P. H., et al., J. Hazard. Mater. 229, 331- 339 (2012); Tan, C. Q., et al., Sep. Purif. Technol. 175, 47-57 (2017)) and other metal-based (e.g., iron (Zhu, S. J., et al., Chem. Eng. J. 365, 99-110 (2019)) and copper (Ren, Y. M., et al., Appl. Catal. B-Environ. 165, 572-578 (2015))) catalysts typically require frequent regeneration. The extreme oxidative condition on the surface of membrane will contribute to prevention and/or mitigation of membrane fouling that otherwise occurs through organic adsorption to the membrane surface (Haberkamp, J., et al., Water Res. 42, 3153-3161 (2008); Zheng, X., et al., Water Res. 65, 414-424 (2014)).

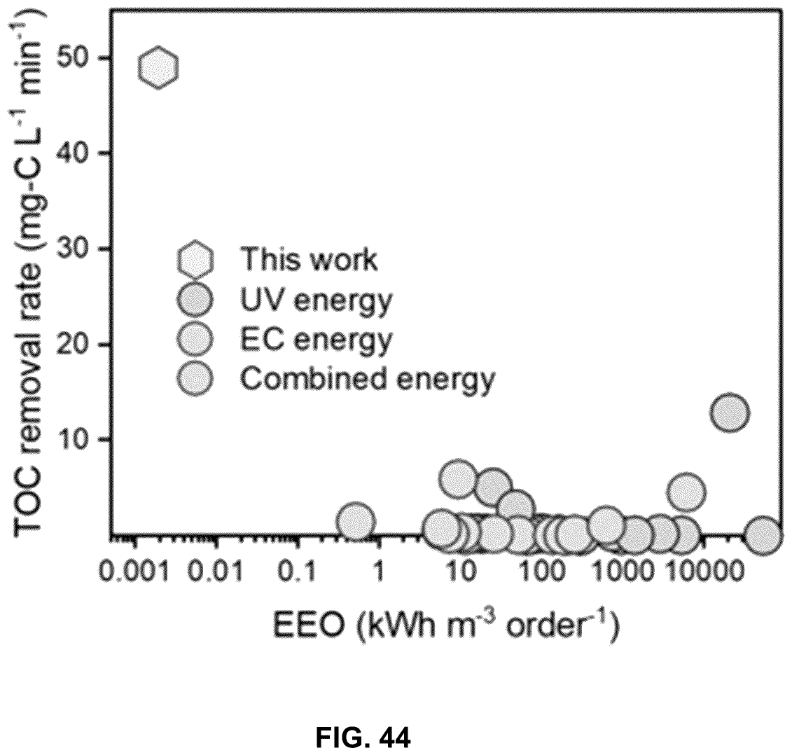

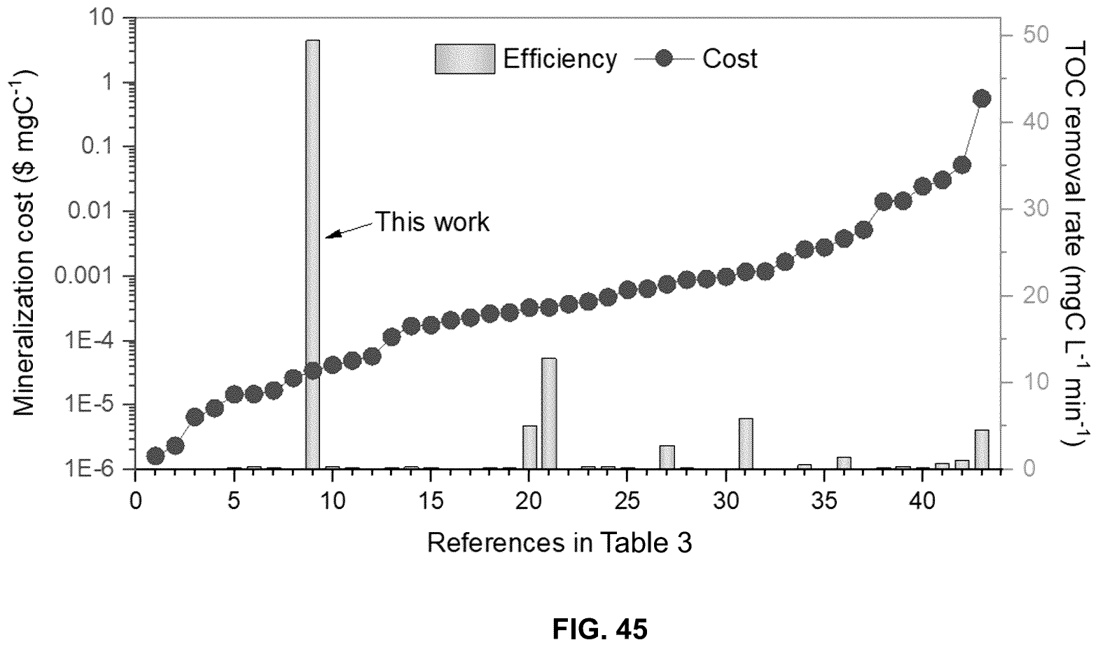

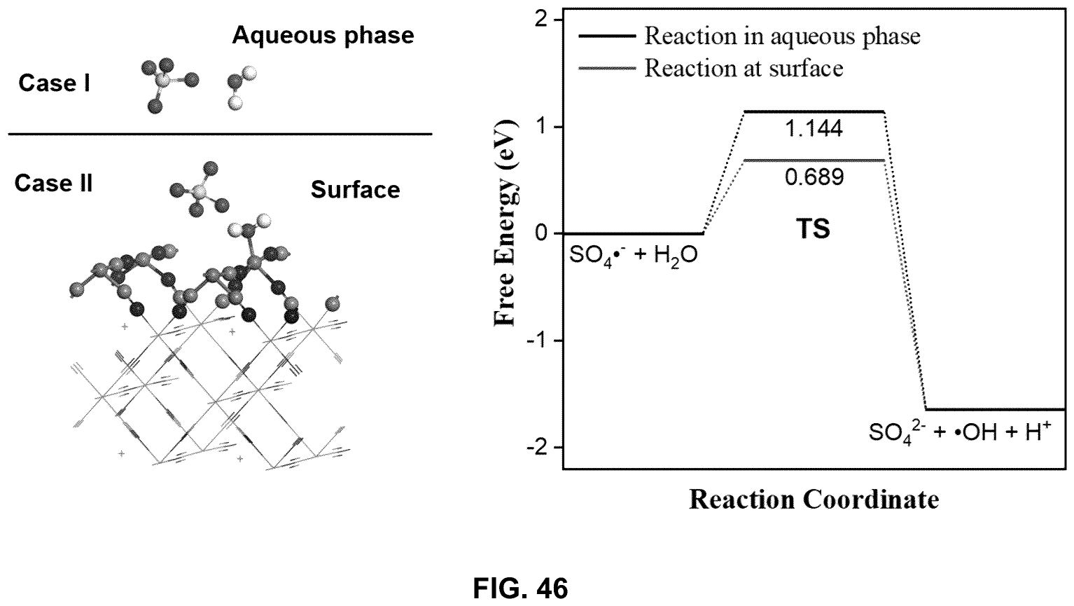

The energy consumption was estimated using electrical energy per order (EEO), a common parameter used to gauge energy efficiency of AOPs, defined by the International Union of Pure and Applied Chemistry (IUPAC). The EEO for AOP driven by the catalytic membrane disclosed herein was compared with EEOs reported for various AOPs employing different activation strategies (see below for calculation details). As shown in FIG. 44, the Co—HCC membrane process, for which the major energy consumption results from transmembrane pressure, has a significantly lower EEO (1.9×10⁻³ kWh m⁻³ order⁻¹) compared to other AOPs (0.5 5×10⁴ kWh m⁻³ order¹; relevant data in Table 5). At the same time, it achieves a significantly higher TOC removal rate (49 mgC L⁻¹ min⁻¹) compared to those 42 comparison technologies surveyed (mostly <1 mgC L⁻¹ min⁻¹). A preliminary cost analysis suggests that this cost to remove TOC (3.8×10⁻⁵ $ per mg-C removal) is one of the lowest in comparison to other reported technologies in the literature (ranging from 1.6×10⁻⁶-5.7 $ per mg-C) (FIG. 45).

TABLE 5
Mineralization efficiency by the membrane disclosed herein and other AOP systems with photo- and/or electro-energies

| | | | | | Starting | | | TOC | EEO | |
|---|---|---|---|---|---|---|---|---|---|---|
| | | | | | TOC | TOC | | removal | (kWh/ | |
| Radical | | | | | (mgC | removal | Time | (mgC | m³/ | |
| source | Catalyst | Reaction system description | pH | Organic | L⁻¹) | (%) | (min) | L⁻¹min⁻¹) | order) | Ref. |
| PMS | Co-HCC | Membrane-confined AOP | 7 | BPA | 100 | 84 | 1.7 | 49.4 | 1.9 × 10⁻³ | This |
| | | | | | | | | | | work |
| UV- | — | Batch photo-reactor (5 × 8 W | 5.1 | BPA | 39.6 | 72.5 | 360 | 0.08 | 951 | ⁷³ |
| PMS | | mercury UV-C light; | | | | | | | | |
| | | λ = 254 nm) | | | | | | | | |
| UV- | — | Batch photo-reactor (5 × 4 W | 7 | Sodium | 0.66 | 100 | 180 | 0.0037 | 300 | ⁷⁴ |
| PMS | | mercury UV-C light; | | alginate | | | | | | |
| | | λ = 254 nm) | | | | | | | | |
| UV- | Co²⁺ | Batch photo-reactor (300 W | NA | Acid | 26.9 | 73 | 300 | 0.0655 | 5276 | ⁷⁵ |
| PMS | | mercury UV light; | | orange 7 | | | | | | |
| | | λ ≤ 365 nm) | | | | | | | | |
| UV- | T@MPAC | Batch photo-reactor (6 W | 7 | Benzo- | 36.3 | 58.5 | 120 | 0.177 | 157 | ⁷⁶ |
| PMS | | UV-C light) | | triazole | | | | | | |
| UV- | γ-Fe₂O₃@AC | Batch photo-reactor (6 W | 4 | Cyfluthrin | 36.5 | 52.4 | 80 | 0.239 | 49.6 | ⁷⁷ |
| PMS | | UV-C light; λ = 254 nm) | | | | | | | | |
| VUV- | Fe²⁺ | Batch photo-reactor (8 W | 7 | Norflox- | 8.64 | 88.85 | 24 | 0.32 | 13.4 | ⁷⁸ |
| PMS | | vacuum UV light; | | acin | | | | | | |
| | | λ₁ = 185 nm; | | | | | | | | |
| | | λ₂ = 254 nm) | | | | | | | | |
| UV- | MNPs@C | Batch photo-reactor (6 W | 6.5 | Acetamin- | 12.7 | 63.5 | 40 | 0.202 | 18.3 | ⁷⁹ |
| PMS | | UV-C light; λ = 254 nm) | | ophen | | | | | | |
| UV- | ZnO@SiO₂@Fe₃O₄ | Batch photo-reactor (8 W | 9 | Diazinon | 9.5 | 56 | 60 | 0.0887 | 74.8 | ⁸⁰ |
| PMS | | UV-C light; λ = 254 nm) | | | | | | | | |
| UV/PMS | CoFe₂O₄@CNT | Batch photo-reactor (8 W | 5.5- | BPA | ≈31.5 | 72.6 | 60 | 0.381 | 47.4 | ⁸¹ |
| | | UV-C light; λ = 254 nm) | 6 | | | | | | | |
| UV- | ZnO-GAC | Batch photo-reactor (6 W | 6.2 | Reactive | ≈31.46 | 43.6 | 60 | 0.229 | 104.9 | ⁸² |
| PMS | | UV-C light; λ = 256 nm) | | Black 5 | | | | | | |
| UV- | Au—TiO₂ | Batch photo-reactor (3 × 250 | 5.8 | Ceftiofur | 11.4 | 96 | 600 | 0.0182 | 53650 | ⁸³ |
| Vis- | | W lamp; λ = 360-2000 nm) | | sodium | | | | | | |
| PMS | | | | | | | | | | |
| UV/US/ | MNPs@C | Batch photo-reactor (UV | 6 | BPA | 23.65 | 56.4 | 60 | 0.222 | 2857 | ⁸⁴ |
| PMS | | lamp 6 W; ultrasonic power | | | | | | | | |
| | | 200 W) | | | | | | | | |
| UV/US/ | Fe/CMK-3 | Batch photo-reactor (UV | 7.8 | BPA | 31 | 80.6 | 78.5 | 0.318 | 99 | ⁸⁵ |
| PMS | | lamp 125 W; ultrasonic | | | | | | | | |
| | | power 80 W) | | | | | | | | |
| UV/EC/ | Fe₃O₄ | Photoelectro-Fenton reactor | 5 | Washing | 202 | 97.1 | 180 | 1.09 | 624 | ⁸⁶ |
| PMS | | (4 W UV-C light; | | machine | | | | | | |
| | | λ = 254 nm; | | effluent | | | | | | |
| | | DC power: 2000 mA, 30 V) | | | | | | | | |
| UV/US/ | — | Batch photo-reactor (UV | 10.2 | WW-IS | 340 | 80 | 60 | 4.53 | 6073 | ⁸⁷ |
| PMS/PDS | | intensity 4.1 W cm⁻²; | | | | | | | | |
| | | ultrasonic power 1280 W) | | | | | | | | |
| UV- | — | Batch photo-reactor (6 W | 7 | Sucralose | ≈18 | 93 | 60 | 0.279 | 20.8 | ⁸⁸ |
| PDS | | UV-C light; λ = 254 nm) | | | | | | | | |
| UV- | Fe(OH)²⁺ | Batch photo-reactor (5 W | 3 | Sul- | 4.8 | 91 | 120 | 0.0364 | 191 | ⁸⁹ |
| PDS | | LED lamp; λ = 365 nm) | | fameth- | | | | | | |
| | | | | oxazole | | | | | | |
| UV/H₂O₂ | — | Batch photo-reactor (10 W | 7 | Roxarsone | 3.7 | 43.2 | 60 | 0.0266 | 203.5 | ⁹⁰ |
| | | UV-C light; λ = 254 nm) | | | | | | | | |
| UV/H₂O₂ | — | Batch photo-reactor (40 W | 3 | Phenol | 37 | 87 | 120 | 0.268 | 47.5 | ⁹¹ |
| | | UV-C light; λ = 253.7 nm) | | | | | | | | |
| UV/H₂O₂ | — | Batch photo-reactor (8 W | 3 | Orange II | 38.4 | 60 | 120 | 0.192 | 80.4 | ⁹² |
| | | UV light) | | | | | | | | |
| UV/H₂O₂ | Fe²⁺ | Batch photo-reactor (12 × 1.4 | 3 | Elderberry | 459 | 99 | 90 | 5.049 | 25.2 | ⁹³ |
| | | W UV-A LED lamp) | | waste- | | | | | | |
| | | | | water | | | | | | |
| UV/H₂O₂ | Fe³⁺ | Batch photo-reactor (250 W | 2 | Sulfonated | ≈3250 | 99 | 250 | 12.87 | 20833 | ⁹⁴ |
| | | Hg(Xe) light source) | | cross- | | | | | | |
| | | | | linked | | | | | | |
| | | | | poly- | | | | | | |
| | | | | styrene | | | | | | |
| UV/H₂O₂ | Fe⁰ | Batch photo-reactor (6 W | 7.3 | Secondary | 8.3 | 92.1 | 360 | 0.0212 | 65.3 | ⁹⁵ |
| | | UV-C light; λ = 254 nm) | | waste- | | | | | | |
| | | | | water | | | | | | |
| | | | | effluent | | | | | | |
| UV/H₂O₂ | Amorphous iron | Batch photo-reactor (4 × 13 | 4 | Phenol | 76.5 | 96 | 180 | 0.408 | 744 | ⁹⁶ |
| | oxide | W fluorescent lamp; | | | | | | | | |
| | | λ = 350-400 nm) | | | | | | | | |
| UV/H₂O₂ | Fe-clay | Batch photo-reactor (8 W | 3 | Orange II | 38.4 | 100 | 120 | 0.32 | 16 | ⁹⁷ |
| | | UV-C light; λ = 254 nm) | | | | | | | | |
| UV/H₂O₂ | Fe-Lap-RD | Batch photo-reactor (8 W | 3 | Reactive | 39.46 | 76 | 120 | 0.25 | 14.3 | ⁹⁸ |
| | | UV-C light; λ = 254 nm) | | Red | | | | | | |
| | | | | HE-3B | | | | | | |
| UV/H₂O₂ | Fe-pillared clay | Batch photo-reactor (15 W | 5.2 | P- | 21.6 | 52.3 | 180 | 0.0628 | 1400 | ⁹⁹ |
| | | UV-C light; λ = 254 nm) | | amino- | | | | | | |
| | | | | benzene- | | | | | | |
| | | | | sulfa- | | | | | | |
| | | | | nilnamide | | | | | | |
| UV/H₂O₂ | Ce—Fe/Al₂O₃ | Batch photo-reactor (72 W | 6 | Yeast | 347.6 | 96.9 | 120 | 2.81 | 47.7 | ¹⁰⁰ |
| | | UV-C light; 36 W UV-A | | plant | | | | | | |
| | | light) | | waste- | | | | | | |
| | | | | water | | | | | | |
| UV/H₂O₂/ | — | Waterfall photocatalysis | 4 | Aniline | ≈33 | 49 | 90 | 0.18 | 164.1 | ¹⁰¹ |
| PDS | | (2 × 8 W UV-C light; | | | | | | | | |
| | | λ = 254 nm) | | | | | | | | |
| EC/PMS | Ti/SnO₂—Sb | Batch two-chamber reaction | NA | PFNA | 11.64 | 85.2 | 90 | 0.11 | 51.4 | ¹⁰² |
| | | cells (voltage 8.3 V; current | | | | | | | | |
| | | 0.25 A) | | | | | | | | |
| EC/PDS | SnO₂—Al₂O₃/CNT | Batch two-chamber reaction | 3 | Ceftaz- | 20 | 45 | 150 | 0.06 | 11.6 | ¹⁰³ |
| | | cells (voltage 1.5 V vs. | | idime | | | | | | |
| | | SCE; current 0.06 A) | | | | | | | | |
| EC/H₂O₂ | Fe²⁺/Fe³⁺ | Batch one-chamber reaction | 6.8 | Landfill | 649 | 73 | 80 | 5.92 | 9.4 | ¹⁰⁴ |
| | | cell (voltage ≈12 V; current | | leachate | | | | | | |
| | | 0.2 A) | | | | | | | | |
| EC/H₂O₂ | Pyrite | Batch one-chamber reaction | 3 | Tyrosol | 28.8 | 89 | 360 | 0.0712 | 136.7 | ¹⁰⁵ |
| | | cell (voltage 18.2 V; current | | | | | | | | |
| | | 0.3 A) | | | | | | | | |
| EC/H₂O₂ | FeOx/NHPC | Batch one-chamber reaction | 6 | Phenol | ≈38.3 | 83 | 420 | 0.0757 | 11.6 | ¹⁰⁶ |
| | | cell (voltage 0.6 V; current | | | | | | | | |
| | | 0.064 A) | | | | | | | | |
| Direct | Ti/IrO₂ anode | Batch one-chamber reaction | 5.6 | Crystal | 147 | 31 | 80 | 0.57 | 5.79 | ¹⁰⁷ |
| EC (Cl⁻/ | | cell (voltage 3.5 V; current | | violet | | | | | | |
| H₂O) | | 0.03 A) | | | | | | | | |
| Direct | Boron-doped | Batch one-chamber reaction | 7.57 | Effluent | 9.6 | 79.03 | 210 | 0.036 | 184 | ¹⁰⁸ |
| EC | diamond anode | cell (voltage ≈8 V; current | | from | | | | | | |
| (H₂O) | | 1.56 A) | | Badajoz | | | | | | |
| | | | | WWTP | | | | | | |
| Direct | Boron-doped | Rotating disk electrode | 4 | PFOS | 38.4 | ≥95 | 25 | 1.46 | 0.512 | ¹⁰⁹ |
| EC | diamond film | reactor (voltage 3.2 V vs. | | | | | | | | |
| (H₂O) | | SHE; current 0.5 A) | | | | | | | | |
| Direct | Boron-doped | Batch undivided | 7.6- | Poly- and | 99 | 91.1 | 600 | 0.15 | 254.85 | ¹¹⁰ |
| EC | diamond anode | flow-by cell (voltage 15.3 | 8.4 | perfluoro- | | | | | | |
| (H₂O) | | V; current 3.5 A) | | alkyl | | | | | | |
| | | | | substances | | | | | | |
| | | | | (PFASs) | | | | | | |
| Direct | Ti/SnO₂—Sb | Batch one-chamber reaction | 7.1 | Coking | 35 | 74.56 | 120 | 0.217 | 25.95 | ¹¹¹ |
| EC | anode | cell (voltage 1.62 V; current | | waste- | | | | | | |
| (H₂O) | | 0.625 A) | | water | | | | | | |
| Direct | Porous Ti₄O₇ | Batch one-chamber reaction | N.A. | PFOA | 48 | ≈95 | 120 | 0.38 | 10.38 | ¹¹² |
| EC | Ceramic | cell (voltage 2.7 V vs. SHE; | | | | | | | | |
| (H₂O) | | current 0.25 A) | | | | | | | | |
| Direct | Ti/ | Batch one-chamber reaction | 3 | M-cresol | 155.4 | 61 | 480 | 0.197 | 7.33 | ¹¹³ |
| EC (anode) + | SnO₂—Sb₂O₅—IrO₂ | cell (voltage −1.0 V of | | | | | | | | |
| EC/H₂O₂ | anode; | cathode potential; current | | | | | | | | |
| (cathode) | carbon-nanotube | 0.09 A) | | | | | | | | |
| | cathode | | | | | | | | | |
| EC- | Carbon-PTFE | Batch one-chamber column | 3 | Oxalic | 48 | 95.3 | 60 | 0.76 | 5.87 | ¹¹⁴ |
| peroxone | cathode | reactor (voltage 7.8 V; | | acid | | | | | | |
| | | current 0.4 A) | | | | | | | | |

⁷³ Sharma, J., et al., Chem. Eng. J. 276, 193-204 (2015)
⁷⁴ Alayande, A. B., et al., Desalination 522: 115437 (2022)
⁷⁵ Chen, X. Y., et al., Chemosphere 67, 802-808 (2007)
⁷⁶ Jorfi, S., et al., Appl. Catal. B-Environ. 219, 216-230 (2017)
⁷⁷ Khaghani, R., et al., Micropor. Mesopor. Mat. 284, 111-121 (2019)
⁷⁸ Wang, C., et al., J. Hazard. Mater. 422: 126884 (2022)
⁷⁹ Noorisepehr, M., et al., Chemosphere 232, 140-151 (2019)
⁸⁰ Rezaei, S. S., et al., J. Environ. Manage. 250: 109472 (2019)
⁸¹ Kakavandi, B., et al., Chemosphere 287: 132024 (2022)
⁸² Liu, F. Z., et al., Sep. Purif. Technol. 279: 119754 (2021)
⁸³ Pugazhenthiran, N., et al., Chem. Eng. J. 241, 401-409 (2014)
⁸⁴ Takdastan, A., et al., Chem. Eng. J. 331, 729-743 (2018)
⁸⁵ Rahimzadeh, H., et al., Water Environ. Res. 92, 189-201 (2020)
⁸⁶ Ghanbari, F. & Martinez-Huitle, C. A. J. Electroanal. Chem. 847: 113182 (2019)
⁸⁷ Grcic, I., et al., Water Res. 46, 5683-5695 (2012)
⁸⁸ Xu, Y., et al., Chem. Eng. J. 285, 392-401 (2016)
⁸⁹ Yan, S., et al., Sep. Purif. Technol. 274: 118991 (2021)
⁹⁰ Chen, L., et al., J. Hazard. Mater. 410: 124558 (2021)
⁹¹ Olmez-Hanci, T. & Arslan-Alaton, I. Chem. Eng. J. 224, 10-16 (2013)
⁹² Feng, J. Y., et al., Water Res. 39, 89-96 (2005)
⁹³ Amor, C., et al., Environ. Technol. Inno. 21: 101183 (2021)
⁹⁴ Feng, H. M., et al., Environ. Sci. Technol. 45, 744-750 (2011)
⁹⁵ Pan, Y. W., et al., Water Res. 153, 144-159 (2019)
⁹⁶ Huang, C. P. & Huang, Y. H. Appl. Catal. A-Gen. 357, 135-141 (2009)
⁹⁷ Feng, J. Y., et al., Water Res. 40, 641-646 (2006)
⁹⁸ Feng, J. Y., et al., Water Res. 37, 3776-3784 (2003)
⁹⁹ Khankhasaeva, S. T. & Badmaeva, S. V. Water Res. 185: 116212 (2020)
¹⁰⁰ Wei, C. H., et al., J. Cent. South Univ. 13, 481-485 (2006)
¹⁰¹ Duran, A., et al., Chemosphere 186, 177-184 (2017)
¹⁰² Wang, K. X., et al., Sci. Total Environ. 758: 143666 (2021)
¹⁰³ Duan, P. Z., et al., J. Environ. Chem. Eng. 8: 103812 (2020)
¹⁰⁴ Ghanbari, F., et al., Chemosphere 279: 130610 (2021)
¹⁰⁵ Ammar, S., et al., Water Res. 74, 77-87 (2015)
¹⁰⁶ Cao, P. K., et al., J. Hazard. Mater. 382: 121102 (2020)
¹⁰⁷ Copete-Pertuz, et al., Sci. Total Environ. 772: 145449 (2021)
¹⁰⁸ Dominguez, J. R., et al., J. Environ. Manage. 298: 113538 (2021)
¹⁰⁹ Carter, K. E. & Farrell, J. Environ. Sci. Technol. 42, 6111-6115 (2008)
¹¹⁰ Ruiz, B. G., et al., Chem. Eng. J. 322, 196-204 (2017)
¹¹¹ He, L., et al., Chemosphere 288: 132362 (2022)
¹¹² Lin, H., et al., Chem. Eng. J. 354, 1058-1067 (2018)
¹¹³ Chu, Y. Y., et al., J. Hazard. Mater. 252, 306-312 (2013)
¹¹⁴ Wang, H. J., et al., Water Res. 80, 20-29 (2015)

### DISCUSSION

The unprecedently high mineralization performance of the Co—HCC membrane can be attributed to its unique catalyst structure that efficiently produces both SO₄⁻ and OH via PMS activation (FIG. 15). Having both SO₄⁻ and OH that are complementary to each other creates an oxidation environment that enables not only oxidation of a broad range of organic pollutants but also their eventual mineralization (Lee, J., et al., Environ. Sci. Technol. 54, 3064-3081 (2020)). Oxidation of organics by OH primarily proceeds with hydrogen abstraction followed by oxygen addition that results in oxygen-rich byproducts such as carboxylates (Oturan, M. A., et al., Electrochim. Acta 54, 173-182 (2008); Garcia-Montano, J., et al., Environ. Sci. Technol. 42, 6663-6670 (2008)). In contrast, SO₄ is more efficient than OH toward electron abstraction from oxygen-rich moieties such as carboxylic groups, leading to decarboxylation and CO₂ release (Norman, R. 0. C., et al., J. Chem. Soc. B 6, 1087-1095 (1970); Madhavan, V., et al., Radiat. Res. 76, 15-22 (1978)). Assuming that Co—HCC catalyzes PMS to produce mostly SO₄⁻ as discussed above (FIG. 23), about 40% of the generated SO₄⁻ would transform to OH, according to the estimated steady-state concentration of SO₄⁻ at about 0.83 μM and *OH at about 0.62 μM for the batch reaction test. This efficient 504⁻ to—OH transformation is caused by the more favorable interaction of SO₄⁻ with H₂O bound to surface Co (energy barrier of 0.689 eV) leading to OH production, compared to SO₄⁻ interaction with H₂O in the bulk phase (energy barrier of 1.144 eV) (FIG. 46).

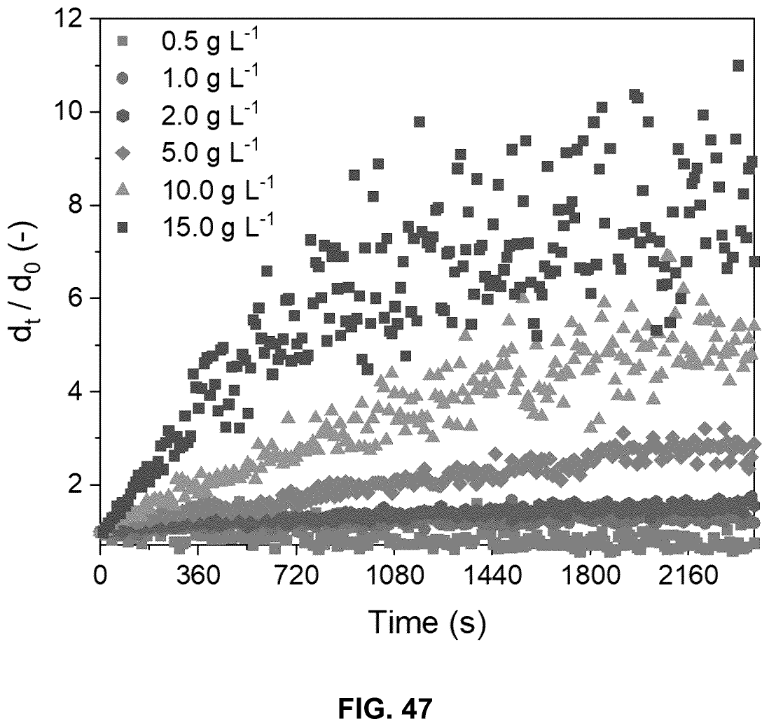

Another critical reason for the high mineralization performance of the Co—HCC membrane is the spatial confinement of surface-catalyzed reactions. All the radical-mediated reactions leading to organic oxidation and mineralization occur inside membrane nanochannels (pore diameter <20 nm) during the flow-through treatment. This nanoscale spatial confinement allows for maximized contact between short-lived radicals (SO₄⁻ lifetime=30-40 μs and OH<10 μs)^{17,70} and the target organic pollutant molecules that pass through the pores. In addition, catalysts immobilized inside the pores provide more accessible surface area compared to catalysts suspended in water. Suspended catalysts undergo severe agglomeration at a concentration higher than 5 g L⁻¹ (FIG. 47). Consequently, a higher loading in a suspension would not guarantee more surface area available for catalysis. In contrast, the catalyst loading in Co—HCC membrane was much higher at 58 g L⁻¹ (15 mg catalyst loaded on membrane with pore volume of 0.26 cm³). In addition to a significant gain in kinetics, the Co—HCC membrane established in this study provides several advantages in engineering practice, enabling a more compact, modular, and versatile AOP applied to various distributed water treatment scenarios.

### Methods

Catalyst synthesis. The Co—HCC catalyst was synthesized using a newly established hydrothermal method. First, 0.55 M glucose and 0.25 M cobalt nitrate hexahydrate were dissolved in deionized water. A ceramic membrane was immersed in this mixture solution, which was then sonicated for 1 hour before being placed on a shaker plate for 24 hours to ensure the penetration of the precursor solution into the pores. The membrane and solution were heated to 260° C. in an autoclave with a temperature ramp rate of 5° C. min⁻¹, kept for 15 h, and naturally cooled to room temperature. The as-synthesized membrane was washed by ethanol and deionized water several times and dried in a vacuum oven before use. The catalyst particles were synthesized following the same procedure but without addition of ceramic membrane.

Synthesis of Co—HCCₚᵣₑ, CoFe₂O₄, and CO₃O₄. Cobalt hexacyanocobaltate with typical (200) facet (i.e., Co—HCCₚᵣₑ) was synthesized using a standard precipitation method with K₃Co(CN)₆precursor and cobalt salt (Deng, L. Q., et al., Adv. Mater. 30: 1802510 (2018); Kaye, S. S. & Long, J. R. J. Am. Chem. Soc. 127, 6506-6507 (2005)). Specifically, K₃Co(CN)₆ (40 mM) was added dropwise into CoCl₂ solution (60 mM) under mixing, with dosing rate of 0.5 mL min⁻¹. The resulting precipitate was centrifuged and washed at least three times with deionized water, and then dried overnight in a vacuum oven. For the synthesis of CoFe₂O₄, a 50 mL solution containing FeCl₃ (0.2 M) and CoCl₂ (0.1 M) was prepared and then dropwise added to 500 mL NaOH solution to form precipitates. The dark brown precipitates were washed by deionized water several times, dried in air at 80° C. for 6 h, annealed under Ar gas at 500° C. for 4 h. For the synthesis of CO₃O₄, 0.17 M cobalt nitrate hexahydrate was dissolved in 10 mL of ethanol solution and heated at 180° C. (temperature ramp rate of 5° C. min⁻¹) for 4 h 180° C. The precipitates were washed with ethanol and deionized water three times, and then dried in air at 80° C. for 6 h.

Catalyst characterization. The morphology of catalyst was examined by SEM (Hitachi SU-70) and TEM (JEM-2000EX, Japan). XRD patterns were acquired using a Rigaku SmartLab X-ray diffractometer with Cu Kα monochromatic radiation operated at 40 kV and 44 mA. Elemental spectra and mapping were captured by EDS coupled with a cold field emission scanning electron microscope (Hitachi SU8230). XPS was conducted on a PHI VersaProbe II Scanning XPS Microprobe with monochromatic Al Kα radiation (1486.6 eV). X-ray absorption spectroscopy (XAS) spectra were collected using a Beamline 8-ID (ISS) of the National Synchrotron Light Source II (Brookhaven National Laboratory, USA), using a Si (111) double crystal monochromator and a passivated implanted planar silicon detector. XAS data were collected at room temperature, energy calibrated with Co foil, and were processed using Demeter XAS analysis software.

Batch and membrane reaction tests. Stock solution for batch reaction (50 mL) contained PMS and model organic compound at pH 7.0. The catalyst powders were first dispersed under sonication and then transferred to the stock solution to initiate the reaction. Samples periodically taken from the reactor were immediately mixed with abundant methanol to quench radicals, centrifuged to remove the solid phase, and analyzed using HPLC. The membrane reactivity was tested using a dead-end filtration setup. In a typical experiment, the catalytic membrane was first fixed inside the reaction module and sealed tightly by O-ring rubber bands to avoid water leakage. The stock solution containing PMS and organic pollutants was fed into the membrane module at prescribed flow rates. For the long-term performance test, the stock solution was replenished every 24 h. The permeate sample was collected and immediately analyzed using HPLC and TOC.

Radical and organic detection. EPR was performed with a Bruker A200 spectrometer (Germany) using 5,5-dimethylpyrroline-oxide (DMPO, 98%) as a spin-trapping agent. The concentration of BPA was detected at 230 nm by HPLC (Agilent Technologies 1260 Infinity), using a 5 m Eclipse XDB-C18 column (4.6 mm×150 mm) as the stationary phase. The mobile phase was acetonitrile (50%) and 0.1% phosphoric acid solution (50%) with a flowrate of 1 mL min⁻¹. The TOC concentrations were determined using a Shimadzu TOC—VCSH analyzer.

Computational methodology. All the DFT calculations were performed using the Vienna Ab initio Simulation Package (VASP) with the projector augmented wave (PAW) method. The exchange-functional was treated using the generalized gradient approximation (GGA) with Perdew-Burke-Emzerhof (PBE) functional. The energy cutoff for the plane wave basis expansion was set to 400 eV. Partial occupancies of the Kohn-Sham orbitals were allowed using the Gaussian smearing method and a width of 0.2 eV. The bulk structure of Co—HCC (10 Co atoms, 12 C atoms, and 12 N atoms), CO₃O₄ (24 Co atoms, and 32 0 atoms), and CoFe₂O₄ (8 Co atoms, 12 Fe atoms, and 32 0 atoms) were optimized with the Monkhorst-Pack k-point of 3×3×3. The Monkhorst-Pack k-point of 2×2 ×1 was applied for the optimizations on Co—HCC (100), Co—HCC (110) and CoN₄ surfaces, and 2×2 ×1 for CO₃O₄ (311) and CoFe₂O₄ (311) surfaces. The self-consistent calculations apply a convergence energy threshold of 10⁻⁵ eV, and the force convergency was set to 0.05 eV/A. The Gibbs free energy (G, eV) corrections were considered at the temperature of 298 K, following ΔG=ΔE+ΔGZPE+ΔGu−TΔS, where ΔE, ΔGZPE, ΔGu, and ΔS refer to the DFT calculated energy change, the correction from zero-point energy, the correction from inner energy and the correction from entropy, respectively.

Determination of the turnover frequency (TOF). The TOF (mole g⁻¹ min⁻¹) can be calculated by dividing the reaction rate of pollutants with radicals by the catalyst concentration,

$$T O F = \frac{{C}_{org .}}{{τ}_{99 \%} \cdot {C}_{catal .}} \qquad ( Eq 1 )$$

where C_{org}. is the molar concentration of organic pollutants, M; τ_{99%} is time spent for a 99% conversion of organic pollutants by radicals, min (this can be determined by ln(0.01)/k_{obs,catal}, where k_{obs,catal}. is the apparent pseudo-first order rate constant); and C_{catal}. is the concentration of catalyst used for reaction, g L⁻¹.

Note that SO₄·⁻ is the direct product of PMS activation and is highly reactive with all the model organics tested (second-order rate constant, k_{SO}_{₄}>3×10⁸ M⁻¹ s⁻¹, Table 1). SO₄⁻ is considered to be the primary oxidant for equation (S1) with the assumption that SO₄⁻ immediately reacts with organics when generated by catalysts. Considering that different organic species have different second-order rate constants with SO₄−, TOF data was taken from the referenced works using BPA as the benchmark, and accordingly adjusted the TOF data as TOF′ for the remaining works using other organic compounds, as shown below,

$$T O {F}^{′} = T O F \times \frac{{k}_{BPA , {SO}_{4} \cdot -}}{{k}_{organic , {SO}_{4} \cdot -}} \qquad ( Eq 2 )$$

where k_{BPA,SO}_{₄} is the second-order rate constant of SO₄·⁻ in reaction with BPA, M⁻¹ s⁻¹; and k_{organic,SO}_{₄} is the second-order rate constant of SO₄⁻ in reaction with other organic species, M⁻¹ S⁻¹

Estimation of radical productivity in membrane and radical consumptionThe theoretical production rate of radicals (Rₜₚ, M s⁻¹) can be estimated based on the catalyst's TOF and concentration within the membrane, as expressed in equation 3,

$${R}_{tp} = \frac{T O F \cdot {C}_{m , catal .}}{60} \qquad ( Eq 3 )$$

where C_{m,catal} is the concentration of catalyst within the membrane, g L⁻¹.

The total consumption rate of radicals can be expressed as the sum of the SO₄⁻ consumption rate (R_{c,SO4}M s⁻¹) and the OH consumption rate (R_{c,OH}, M s⁻¹), as can be expressed in equations 4 and 5

$${R}_{c , {SO}_{{4}^{. -}}} = {C}_{S {O}_{{4}^{. -}}} \times ( {C}_{{Cl}^{-}} \cdot {k}_{{Cl}^{-} / S {{O}_{4}}^{. -}} + {C}_{H C {O}_{3}^{-}} \cdot {k}_{H C {O}_{3}^{-} / {SO}_{{4}^{. -}}} ) \qquad ( Eq 4 )$$

$${R}_{c , \cdot OH} = {C}_{\cdot OH} \times ( {C}_{{Cl}^{-}} \cdot {k}_{{Cl}^{-} / \cdot OH} + {C}_{H C {O}_{3}^{-}} \cdot {k}_{H C {O}_{3}^{-} / \cdot OH} ) \qquad ( Eq 5 )$$

where C_{SO}_{₄} and C_{OH} represent the steady-state concentrations of SO₄·⁻ and OH, respectively, with coexisting Cl⁻ and HCO₃⁻ (data can be obtained from the kinetic profile in FIG. 41), M; C_{Cl}- and C_{HCO}— are the concentrations of Cl⁻ and HCO₃⁻, respectively, M; k_{Cl-}/_{SO}_{₄} and k_{HCO}⁻/SO₄ represent the second-order rate constants of SO₄⁻ in reaction with Cl⁻ (4.7×108 M⁻¹ s⁻¹)1 and HCO₃⁻ (9.1×10⁶ M⁻¹ s⁻¹)², respectively, M⁻¹ s⁻¹; and k_{Cl-}/-_{OH} and k_{HCO}⁻/-_{OH} represent the second-order rate constants of *OH in reaction with Cl⁻ (4.3×10⁹ M⁻¹ s⁻¹)₃ and HCO₃⁻ (8.5×10⁶ M⁻¹ s⁻¹)₄ respectively, M⁻¹ s⁻¹.

Noting that the product of OH and Cl⁻ interactions, i.e., ClHO, would quickly decompose back to OH and Cl⁻ again (k_{ClHO}⁻=6.1×10⁹ M⁻¹ s¹)₃, the first term in equation 5 can be eliminated and then the total consumption rate of radicals (R_{c,total}) can be expressed in equation 6,

$${R}_{c , total} = {R}_{c , {{SO}_{4}}^{. -}} + {C}_{H C {O}_{3}^{-}} \cdot {C}_{\cdot OH} \cdot {k}_{H C {O}_{3}^{-} / \cdot OH} \qquad ( Eq 6 )$$

Determination of EEO. EEO refers to the number of kilowatt-hours (kWh) of electrical energy required to reduce the TOC by one order of magnitude (90%) in 1 m³ of contaminated water (unit: kWh/m³/order). Its value can be calculated by

$$EEO = \frac{{E}_{o p} \cdot {τ}_{0.1}}{{V}_{r}} \qquad ( Eq 7 )$$

where Eₒₚ is the output power, kW; τ_{0.1} is the time required for 90% reduction of TOC, h; and Vᵣis the liquid volume for reaction, m³.

The EEO for the membrane was determined by equation 8,

$${C}_{m} = \frac{P \cdot V \cdot {τ}_{0.1}}{3600} \qquad ( Eq 8 )$$

where P is the transmembrane pressure, about 6.89 kPa for 20 LMH; and V is a unit water volume, 1 m³.

Cost analysis. The cost for TOC removal (C_{TOC}, $ per mg-C) was calculated through dividing the cost for the treatment of each cubic meter wastewater (C_{V}, $ m⁻³) by the removed TOC (mg-C L⁻¹), expressed as

$${C}_{T O C} = \frac{{C}_{V}}{T O {C}_{R} \times 1000} \qquad ( Eq 9 )$$

The parameter C_{V} can be calculated as a sum of the cost of chemical reagents (C_{C}, $ m⁻³) and the cost of photo—and/or electrical energies (C_{E}, $ m⁻³). The Cc can be obtained by multiplying the concentration of chemical precursors used for the generation of radicals (Cp, kg m⁻³) with their market price (P_{M}, $ kg⁻¹), and the C_{E} can be obtained by multiplying the EEO (kWh/m³/order) with the price of energy (P_{E}, $ per kWh; this was assessed with 0.116 $ per kWh according to the USA generation services charge).

Then, the C_{y} can be calculated based on equation 10,

$${C}_{V} = {C}_{C} + {C}_{E} = {C}_{p} \cdot {P}_{M} + E E O \cdot {P}_{E} \qquad ( Eq 10 )$$

Determination of SO₄⁻ and OH concentrations. The steady-state concentration of SO₄·⁻ can be calculated by equation 11, with the assumption that TBA has completely quenched OH and methanol has completely quenched SO₄⁻.

$${C}_{{SO}_{4}^{\cdot -}} = \frac{{k}_{obs , TBA} - {k}_{obs , methanol}}{{k}_{BPA / {SO}_{4}^{\cdot -}}} \qquad ( Eq 11 )$$

where k_{obs,TBA} is the rate constant of BPA degradation in the presence of TBA, s⁻¹; k_{obs,methanol} is the rate constant of BPA degradation in the presence of methanol, s⁻¹; and k_{BPA}/SO₄ is the second-order rate constant for BPA in reaction with SO₄−, 4.49×10⁹ M⁻¹ s⁻¹

The steady-state concentration of OH can be calculated by equation 12:

$${C}_{\cdot OH} = \frac{{k}_{o b s , catal .} - {k}_{obs , TBA}}{{k}_{BPA / \cdot OH}} \qquad ( Eq 12 )$$

where k_{obs,catal}. is the rate constant of BPA degradation with catalyst, s⁻¹; and k_{BPA}/OH is the second-order rate constant for BPA in reaction with OH, 6.9×10⁹ M⁻¹ s^{-1.6}.

Hydrothermal Treatment. Hydrothermal treatment (180-240° C.) of glucose as a typical saccharide produces carbonaceous microspheres (Romero-Anaya, A. J., et al., Carbon 68, 296-307 (2014)), along with abundant oxygen groups in the shells of the particles (Sevilla, M. & Fuertes, A. B., et al., Carbon 47, 2281-2289 (2009). This is quite similar to the spherical carbon particles that we collected after hydrothermal treatment at 240° C. (FIG. 5). Gasification of hydrocarbons, like glucose, normally occurs under supercritical and/or subcritical water conditions (>300° C.), giving rise to molecular hydrogen (H₂) along with other byproducts, such as CO and CH₄(Fiebig, J., et al., Geochim. Cosmochim. Ac. 71, 3028-3039 (2007)). The temperature required for initiating gasification can be significantly lowered to around 230° C. in the presence of catalysts, such as Co₃O₄/CeO₂ and Pt/Al₂O₃(Yu, S. W., et al., Int. J. Hydrogen. Energ. 39, 20700-20711 (2014); Cortright, R. D., et al., Nature 418, 964-967 (2002)), which makes gasification possible under hydrothermal condition with homogeneous Co²⁺ catalyst (presumably 240-260° C.). Upon generation, the H₂ product readily reduces NO₃⁻ (from cobalt nitrate precursor) to N₂, and part of N₂ would be further reduced to NH₃ under Co catalysis (cobalt facilitates the N-N bond cleavage) (Wang, X. Y., et al., Nat. Commun. 11: 653 (2020)). Finally, the cyanide bond (i.e., C-N) would be formed, either at the surface or in the bulk phase, through reactions between gaseous mixtures containing both the gasification products (e.g., CO and CH₄) and the nitrate reduction products (N₂ and NH₃). Relevant reactions follow a quite similar pathway to the formation of hydrogen cyanide under abiotic hydrothermal processes in nature (Zahnle, K. J. J. Geophys. Res.-Atmos. 91, 2819-2834 (1986); Holm, N. G. & Neubeck, A. Geochem. Trans. 10: 9 (2009)). The formation of CN- at the carbon substrate surface starts the nucleation process of the Co₃[Co(CN)₆]₂ structure when it reacts with local Co²⁺/Co³” cations. The growth of the nucleus closely correlates with the interface crystal-substrate interactions, and for our catalyst, the morphology turned out to be layered along with a preferred (400) facet under our synthetic conditions.

Structure Analyses. EXAFS is a powerful tool that can allow the determination of CN and coordinating atom identity. Co—HCC to appears to have a repeating Co^{II}—N—C—Co^{III} structure, which introduces complications to conducting a fit to find CN. Mainly, this proposed structure contains multiple Co atoms linearly in a path (FIG. 14), resulting in multiple scattering effects. Attempting to fit using the reference K₃Co(CN)₆ yielded challenges in fitting the second shell peak of Co—HCC (2.86 Å versus 2.60 Å in K₃Co(CN)₆). Lastly, attempting to fit Co—HCC to the DFT predicted structure cannot reflect the entirety of the catalyst, as DFT was constructed using a small unit cell involving the unsaturated surface atoms and misses the bulk, while XAS reflects the entirety of the material. While such complications hinder using EXAFS to find the Co—N/C CN in Co—HCC, the strong evidence of other characterization techniques, such as XRD, TEM, and EDS, support the proposed crystal structure of the hydrothermally grown Co—HCC.

BPA Removal Rate. The removal rate of BPA continuously decreased with reduced retention time caused by the increased water flux. According to the BPA concentration in the permeate relative to that in the inlet solution (C_{out, BPA}/C_{in, BPA}) versus the retention time (inset figure), one can see that the relevant data exhibited good linear correlation (R²>0.98), and thus one can obtain the apparent reaction constant by this membrane reactor (k_{obs,membrane}, s⁻¹) Then the steady-state concentrations of SO₄⁻ (C_{SO}_{₄}, M) and OH (C_{OH}, M) can be expressed by equation 13,

$${k}_{obs , membrane} = {C}_{{SO}_{{4}^{\cdot -}}} \cdot {k}_{B P A / S {O}_{4}^{\cdot -}} + {C}_{O H} \cdot {k}_{BPA / \cdot OH} \qquad ( Eq 13 )$$

Considering that the second-order rate constants for BPA in reaction with SO₄⁻ (4.49×10⁹ M⁻¹ s⁻¹⁵) and OH (6.9×10⁹ M⁻¹ s⁻¹⁶) are quite close to each other, the terms for second-order constants can be approximated with a value of 5.7×10⁹ M⁻¹ s⁻¹. Note that the relative abundance of SO₄·⁻ and OH was about 0.83/0.62, and so one can respectively get C_{SO}_{₄} (4.4×10⁻¹¹ M) and C_{OH} (5.9×10⁻¹¹ M) to further calculate the radical consumption.

Selection of organic pollutants for TOC analysis. Given the complexity of organic constituents in real wastewater, model compounds were selected based on their prevalence in literature and existing databases. Aniline and Rhodamine B (RhB) were chosen as representative chemicals in the paper and chemical industries, respectively, as documented by the U.S. EPA Toxics Release Inventory (TRI) Pollution Prevention Industry Profile database. Terephthalic acid (TPA) is a major pollutant reported in the food industry. For hospital wastewater, acetaminophen (APAP) was selected as a pharmaceutical present in these effluents that poses major public health risks. For municipal wastewater, natural organic matter (NOM) and 4-chlorophenol (4-CP) were chosen for their widespread abundance. Organic matter in particular can become highly concentrated in RO-based processes, in which oxalic and other carboxylic acids have been noted to be relatively more stable and difficult to mineralize in the post-treatment steps. Hence, oxalic acid (OA) was chosen as a model organic pollutant in the scope of ROC solutions.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

1. A catalytic material comprising a hexacyano metal compound;
wherein the hexacyano metal compound comprises a metal selected from the group consisting of cobalt, iron, copper, manganese, nickel, zinc, and combinations thereof;
wherein the hexacyano metal compound comprises coordinatively unsaturated metal (II)—N—C centers; and
wherein the hexacyano metal compound is anchored onto an inorganic substrate.

2. The catalytic material of claim 1, wherein the hexacyano metal compound includes specific facets.

3. The catalytic material of claim 2, wherein the specific facets comprise dominant (400) and (220) facets.

4. The catalytic material of claim 2, wherein the hexacyano metal compound comprises cobalt hexacyanocobaltate with dominant (400) and (220) facets.

5. The catalytic material of claim 1, wherein the inorganic substrate comprises inorganic granules or porous inorganic scaffolds.

6. The catalytic material of claim 5, wherein the porous inorganic scaffold is a ceramic microfiltration membrane or a ceramic ultrafiltration membrane.

7. The catalytic material of claim 5, wherein the catalytic material is disposed within the interstitial spaces of the porous inorganic scaffold.

8. The catalytic material of claim 5, wherein the porous inorganic scaffold is a water filtration membrane.

9. The catalytic material of claim 7, wherein the interstitial spaces range in size from 1 to 500 nanometers.

10-13. (canceled)

14. A method of making a catalytic material, the method comprising the steps of:
providing a solution comprising a metal salt and an organic substrate precursor; and
heating the solution under pressure to form a catalytic material;
wherein the metal salt comprises a metal selected from the group consisting of cobalt, iron, chromium, copper, manganese, nickel, vanadium, zinc and combinations thereof.

15-17. (canceled)

18. The method of claim 14, wherein the metal salt is cobalt nitrate and the organic precursor is glucose.

19. The method of claim 14, further comprising the steps of:
contacting the solution comprising a metal salt and an organic substrate precursor with an inorganic substrate; and
heating the combination of the inorganic substrate and the solution at an effective temperature and for a sufficient time to form and anchor the catalytic material onto the inorganic substrate.

20-25. (canceled)

26. An oxidation process system comprising a containerized vessel, wherein said containerized vessel comprises the catalytic material of claim 1 anchored to a porous inorganic scaffold.

27-45. (canceled)

46. An oxidation process for treating an aqueous source comprising the step of contacting an aqueous source with a peroxide precursor in the presence of a catalytic material;
wherein the catalytic material comprises hexacyano metal compound anchored onto an inorganic substrate;
wherein the hexacyano metal compound comprises a metal selected from the group consisting of cobalt, iron, copper, manganese, nickel, zinc and combinations thereof; and
wherein the hexacyano metal compound comprises coordinatively unsaturated metal (II)—N—C centers.

47-55. (canceled)

56. The oxidation process of claim 46, wherein the step of contacting the peroxide precursor with the aqueous solution in the presence of the catalytic material further comprises the step of breaking the peroxide bonds in the peroxide precursor; wherein the peroxide precursor is selected from the group consisting of peroxymonosulfate, peroxydisulfate, peracetic acid, percarbonic acid, percarbonate, hydrogen peroxide and combinations thereof.

57. The oxidation process of claim 56, wherein the step of breaking the peroxide bonds in the peroxide precursor produces reactive radicals selected from the group consisting of hydroxyl radicals, sulfate radicals, acetate radicals, carbonate radicals and combinations thereof.

58. The oxidation process of claim 56, wherein a residual peroxide concentration is less than 10 ppm.

59. The oxidation process of claim 46, wherein the aqueous source comprises organic pollutants.

60. The oxidation process of claim 46, wherein the aqueous source is selected from the group consisting of municipal wastewater, industrial wastewater, ground water, and surface water.

61. The oxidation process of claim 59, wherein the catalytic material degrades the organic pollutants in the aqueous sources.
